(19) United States
(12) Patent Application Publication
(10) Pub. No.: US 2017/0329995 A1
(43) Pub. Date: Nov. 16, 2017

(54) ANTI-REPLAY TECHNIQUES USING SECURE EXTERNAL NON-VOLATILE MEMORY

(71) Applicant: QUALCOMM Incorporated, San Diego, CA (US)

(72) Inventors: Olivier Jean Benoit, San Diego, CA (US); Satish ANAND, San Diego, CA (US); David TAMAGNO, Livermore, CA (US)

(21) Appl. No.: 15/230,091

(22) Filed: Aug. 5, 2016

Related U.S. Application Data
(60) Provisional application No. 62/334,407, filed on May 10, 2016.

(51) Int. Cl. G06F 21/64; G06F 21/70; H04L 9/08; H04L 9/32

(52) U.S. Cl. CPC G06F 21/64; H04L 9/3242; G06F 21/70; H04L 9/0861

(57) ABSTRACT

Techniques for providing data protection in an integrated circuit are provided. A method according to these techniques includes exchanging messages with an off-chip, non-volatile memory to securely initialize an anti-replay counter (ARC) value in the integrated circuit based on an ARC value stored in the off-chip, non-volatile memory, and maintaining the ARC value stored in the integrated circuit such that the ARC value stored in the integrated circuit remains synchronized with the ARC value stored in the off-chip, non-volatile memory.

### CROSS REFERENCE TO RELATED APPLICATION

This application claims priority to U.S. Provisional Patent Application Ser. No. 62/334,407, entitled “ANTI-REPLAY TECHNIQUES USING SECURE EXTERNAL NON-VOLATILE MEMORY,” filed on May 10, 2016, all of which are assigned to the assignee hereof and incorporated by reference.

### BACKGROUND

Data security is a critical issue for many computing devices. Computing devices can include secure processing subsystem that may be implemented as a secure area of a processor of the computing device or may include a separate processor and memory that can be used to store data. The secure processing subsystem may be implemented as a system-on-a-chip (SoC) or other similar device that includes a processor element and memory implemented on an integrated circuit. However, the amount of memory available on the integrated circuit may be limited and an external non-volatile memory (NVM) may be used to store data used by the secure processing subsystem. Confidentiality of the data stored in the NVM can be ensured through the use of encryption, and the integrity of the data stored in the NVM can be ensured through the use of digital signatures. However, an attacker may attempt to restore an old copy of the data to the NVM which is validly signed and/or encrypted by the secure processing system in what is referred to as a rollback or replay attack. Accordingly, additional protections are required for data stored in an NVM.

### SUMMARY

An example method for providing data protection in an integrated circuit according to the disclosure includes exchanging messages with an off-chip, non-volatile memory to securely initialize an anti-replay counter (ARC) value in the integrated circuit based on an ARC value stored in the off-chip, non-volatile memory, and maintaining the ARC value stored in the integrated circuit such that the ARC value stored in the integrated circuit remains synchronized with the ARC value stored in the off-chip, non-volatile memory.

Implementations of such a method may include one or more of the following features. Exchanging messages with the off-chip, non-volatile memory to securely initialize the anti-replay counter (ARC) value in the integrated circuit from the ARC value stored in the off-chip, non-volatile memory includes receiving a message from the off-chip, non-volatile memory that includes the ARC value stored in the off-chip, non-volatile memory and a first nonce value; sending a first response from the integrated circuit that includes a local second nonce value and a first cryptogram value encrypted using a secret key known to the integrated circuit and the off-chip, non-volatile memory; and receiving a second response to the integrated circuit that includes a second cryptogram value encrypted using the secret key. The first cryptogram value includes a cryptogram computed of the first nonce value, second nonce value, and the ARC value. Authenticating the second response by computing a local cryptogram using the first nonce value and the ARC value received in the message from the off-chip, non-volatile memory, and the local second nonce value, and comparing the second cryptogram value and the local cryptogram to determine whether the second response is authentic. Maintaining the ARC value stored in the integrated circuit such that the ARC value stored in the integrated circuit remains synchronized with the ARC value stored in the off-chip, non-volatile memory includes sending a read request from the integrated circuit to obtain encrypted data stored in the off-chip, non-volatile memory, the read request comprising an address in the off-chip, non-volatile memory at which the data is stored and a first transaction authentication value, receiving a response message from the off-chip, non-volatile memory that includes the encrypted data, a MAC or a cryptographic signature associated with the data, and a second transaction authentication value, authenticating the response message based on the second transaction authentication value, and responsive to the response message being authenticated, incrementing the ARC value stored in the integrated circuit. Authenticating the message based on the second transaction authentication value includes determining a keyed-hash message authentication code (HMAC) of the address (as provided in the read request) in the off-chip, non-volatile memory at which the data was to be read, combined with the received encrypted data using a trusted key, and comparing the HMAC to the second transaction authentication value. Determining the trusted key by applying a key derivation function to the secret key and the ARC value stored in the integrated circuit. Maintaining the ARC value stored in the integrated circuit such that the ARC value stored in the integrated circuit remains synchronized with the ARC value stored in the off-chip, non-volatile memory includes sending a write request to write encrypted data to the off-chip, non-volatile memory from the integrated circuit, the write request comprising an address in the off-chip, non-volatile memory at which the data is to be stored, the encrypted data, and a first transaction authentication value, receiving a response message from the off-chip, non-volatile memory that the write request was completed, the response message comprising a second transaction authentication value, authenticating the response message based on the second transaction authentication value, and responsive to the response message being authenticated, incrementing the ARC value stored in the off-chip, non-volatile memory. Authenticating the response message based on the second transaction authentication value includes determining a keyed-hash message authentication code (HMAC) of the address and the encrypted data (as provided in the write request) using a trusted key, and comparing the HMAC to the second transaction authentication value. Determining the trusted key by applying a key derivation function to the secret key and the ARC value stored in the off-chip, non-volatile memory.

An example integrated circuit according to the disclosure includes means for exchanging messages with an off-chip, non-volatile memory to securely initialize an anti-replay counter (ARC) value in the integrated circuit based on an ARC value stored in the off-chip, non-volatile memory, and means for maintaining the ARC value stored in the integrated circuit such that the ARC value stored in the integrated circuit remains synchronized with the ARC value stored in the off-chip, non-volatile memory.

Implementations of such an integrated circuit can include one or more of the following features. The means for exchanging messages with the off-chip, non-volatile memory to securely initialize the anti-replay counter (ARC) value in the integrated circuit from the ARC value stored in the off-chip, non-volatile memory includes means for receiving a message from the off-chip, non-volatile memory that includes the ARC value stored in the off-chip, non-volatile memory and a first nonce value, means for sending a first response from the integrated circuit that includes a local second nonce value and a first cryptogram value encrypted using a secret key known to the integrated circuit and the off-chip, non-volatile memory, and means for receiving a second response to the integrated circuit that includes a second cryptogram value encrypted using the secret key. The first cryptogram value comprises a cryptogram computed of the first nonce value, second nonce value, and the ARC value. Means for authenticating the second response including means for computing a local cryptogram using the first nonce value and the ARC value received in the message from the off-chip, non-volatile memory, and the local second nonce value, and means for comparing the second cryptogram value and the local cryptogram to determine whether the second response is authentic. The means for maintaining the ARC value stored in the integrated circuit such that the ARC value stored in the integrated circuit remains synchronized with the ARC value stored in the off-chip, non-volatile memory includes means for sending a read request from the integrated circuit to obtain encrypted data stored in the off-chip, non-volatile memory, the read request comprising an address in the off-chip, non-volatile memory at which the data is stored and a first transaction authentication value, means for receiving a response message from the off-chip, non-volatile memory that includes the encrypted data, a MAC or a cryptographic signature associated with the data, and a second transaction authentication value, means for authenticating the response message based on the second transaction authentication value, and means for responsive to the response message being authenticated, incrementing the ARC value stored in the integrated circuit.

A computing device according to the disclosure includes an integrated circuit that includes a secure processing subsystem. The secure processing subsystem is configured to exchange messages with an off-chip, non-volatile memory to securely initialize an anti-replay counter (ARC) value in the integrated circuit based on an ARC value stored in the off-chip, non-volatile memory, and maintain the ARC value stored in the integrated circuit such that the ARC value stored in the integrated circuit remains synchronized with the ARC value stored in the off-chip, non-volatile memory.

Implementations of such an integrated circuit can include one or more of the following features. The secure processing subsystem being configured to exchange messages with the off-chip, non-volatile memory to securely initialize the anti-replay counter (ARC) value in the integrated circuit from the ARC value stored in the off-chip, non-volatile memory is further configured to receive a message from the off-chip, non-volatile memory that includes the ARC value stored in the off-chip, non-volatile memory and a first nonce value, send a first response from the integrated circuit that includes a local second nonce value and a first cryptogram value encrypted using a secret key known to the integrated circuit and the off-chip, non-volatile memory, and receive a second response to the integrated circuit that includes a second cryptogram value encrypted using the secret key. The first cryptogram value comprises a cryptogram computed of the first nonce value, second nonce value, and the ARC value. The secure processing subsystem is configured to authenticate the second response, the secure processing subsystem being further configured to compute a local cryptogram using the first nonce value and the ARC value received in the message from the off-chip, non-volatile memory, and the local second nonce value, and compare the second cryptogram value and the local cryptogram to determine whether the second response is authentic. The secure processing being configured to maintain the ARC value stored in the integrated circuit such that the ARC value stored in the integrated circuit remains synchronized with the ARC value stored in the off-chip, non-volatile memory further is further configured to send a read request from the integrated circuit to obtain encrypted data stored in the off-chip, non-volatile memory, the read request comprising an address in the off-chip, non-volatile memory at which the data is stored and a first transaction authentication value, receive a response message from the off-chip, non-volatile memory that includes the encrypted data, a MAC or a cryptographic signature associated with the data, and a second transaction authentication value, authenticate the response message based on the second transaction authentication value; and increment the ARC value stored in the integrated circuit responsive to the response message being authenticated.

A non-transitory, computer-readable medium, having stored thereon computer-readable instructions for providing data protection in an integrated circuit according to the disclosure includes instructions configured to cause a computer to exchange messages with an off-chip, non-volatile memory to securely initialize an anti-replay counter (ARC) value in the integrated circuit based on an ARC value stored in the off-chip, non-volatile memory, and maintain the ARC value stored in the integrated circuit such that the ARC value stored in the integrated circuit remains synchronized with the ARC value stored in the off-chip, non-volatile memory.

### BRIEF DESCRIPTION OF THE DRAWINGS

FIG. 1 is a functional block diagram of an example computer system illustrating the techniques disclosed herein.

FIG. 2 is a functional block diagram of an example computer system that can be used to implement the computer system illustrated in FIG. 1.

FIG. 3 is an illustration of an example process for negotiating between an external non-volatile memory (NVM) and a secure processing subsystem to establish an anti-replay counter according to the techniques disclosed herein.

FIG. 4 is a flow diagram of an example process for securing a read request using an anti-replay counter according to the techniques disclosed herein.

FIG. 5 is a flow diagram of an example process for securing a write request using an anti-replay counter according to the techniques disclosed herein.

FIG. 6 is a flow diagram of an example process for maintaining an anti-replay counter according to the techniques disclosed herein.

FIG. 7 is a flow diagram of an example process negotiating with a secure processing subsystem to establish an anti-replay counter according to the techniques disclosed herein.

FIG. 8 is a flow diagram of an example process for maintaining an anti-replay counter according to the techniques disclosed herein.

FIG. 9 is a flow diagram of an example process negotiating with an external NVM to establish an anti-replay counter according to the techniques disclosed herein.

FIG. 10 is a flow diagram of an example process for securing a read request using an anti-replay counter according to the techniques disclosed herein.

FIG. 11 is a flow diagram of an example process for securing a read request using an anti-replay counter according to the techniques disclosed herein.

FIG. 12 is a flow diagram of an example process for securing a write request using an anti-replay counter according to the techniques disclosed herein.

FIG. 13 is a flow diagram of an example process for securing a write request using an anti-replay counter according to the techniques disclosed herein.

### DETAILED DESCRIPTION

Technique for providing for maintaining an anti-replay counter (ARC) for preventing anti-replay attacks are provided. The techniques disclosed herein can be used to prevent replay attacks on data stored in an off-chip non-volatile memory by an integrated circuit, such as a system on a chip (SoC). The persistent copy of the ARC value can be maintained by the non-volatile memory according to other example embodiments, and a copy of the ARC value can be established and maintained in the volatile memory of a secure processing subsystem of the SoC based on the persistent copy of the ARC value maintained by the non-volatile memory.

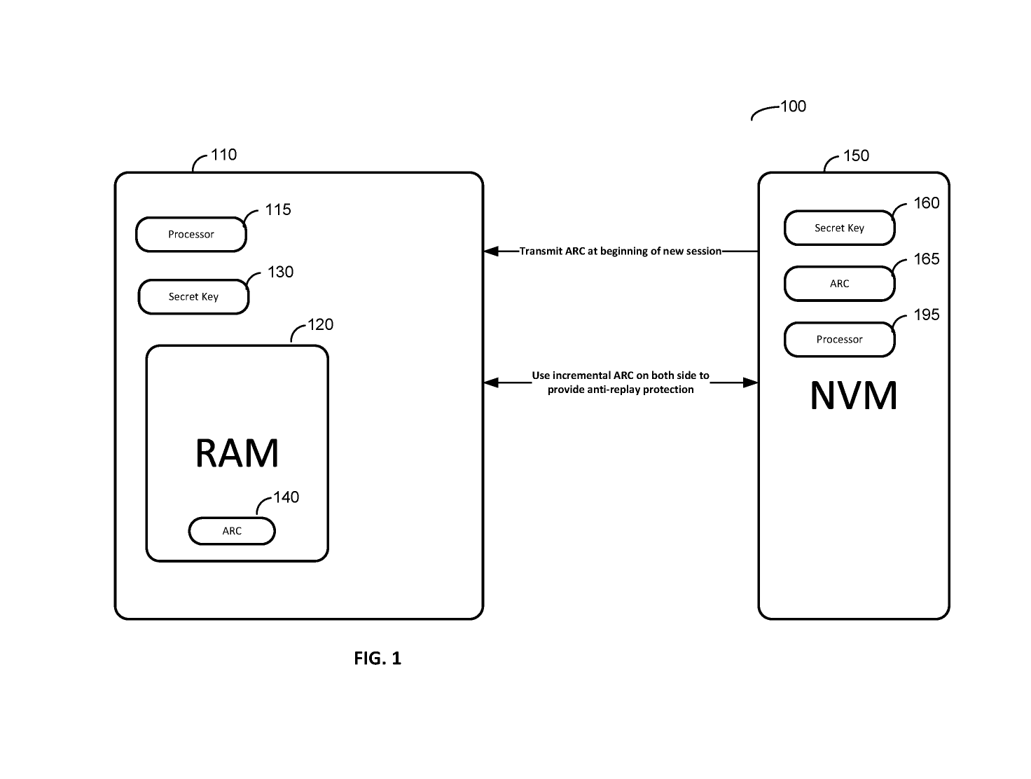

FIG. 1 is a functional block diagram of an example computing device 100 illustrating the techniques disclosed herein. The secure processing subsystem 110 of the implementation illustrated in FIG. 1 is not configured to maintain a persistent copy of the anti-replay counter. Instead, the NVM 150 maintains the ARC value 165 and the secure processing subsystem 110 can be configured to maintain a copy of the ARC value 140 in the volatile memory 120 of the secure processing subsystem 110.

The computing device 100 comprises a secure processing subsystem 110 and a non-volatile memory (NVM) 150 external to the secure processing subsystem 110 that can be used by the secure processing subsystem 110 to store data. The secure processing subsystem 110 can be configured to communicate with the NVM 10 across a data bus or other such medium for communicating data between the secure processing subsystem 110 and the NVM 150. The secure processing subsystem 110 may be implemented on an integrated circuit and the NVM 150 may be implemented as an off-chip memory that is not implemented on the integrated circuit on which the secure processing subsystem 110. The secure processing subsystem 110 can provide a secure execution environment for processor-executable program code and for secure data storage that can prevent unauthorized access to the data stored therein and/or prevent unauthorized execution of processor-executable program instructions by a processor of the secure processing subsystem 110.

The secure processing subsystem 110 can include a processor 115 that can implement the various functions, processes, and functional elements discussed herein with regard to the secure processing subsystem 110. The secure processing subsystem can be implemented by a general purpose processor of the computing device 100, which can be configured to segregate secure processing resources and memory from general processing resources and memory for non-secure applications.

The NVM 150 can comprise a processor 195. The processor 195 can be a memory controller for managing the flow of data going to and from the NVM 150. The processor 195 can implement the various functions, processes, and functional elements discussed herein with regard to the NVM 150.

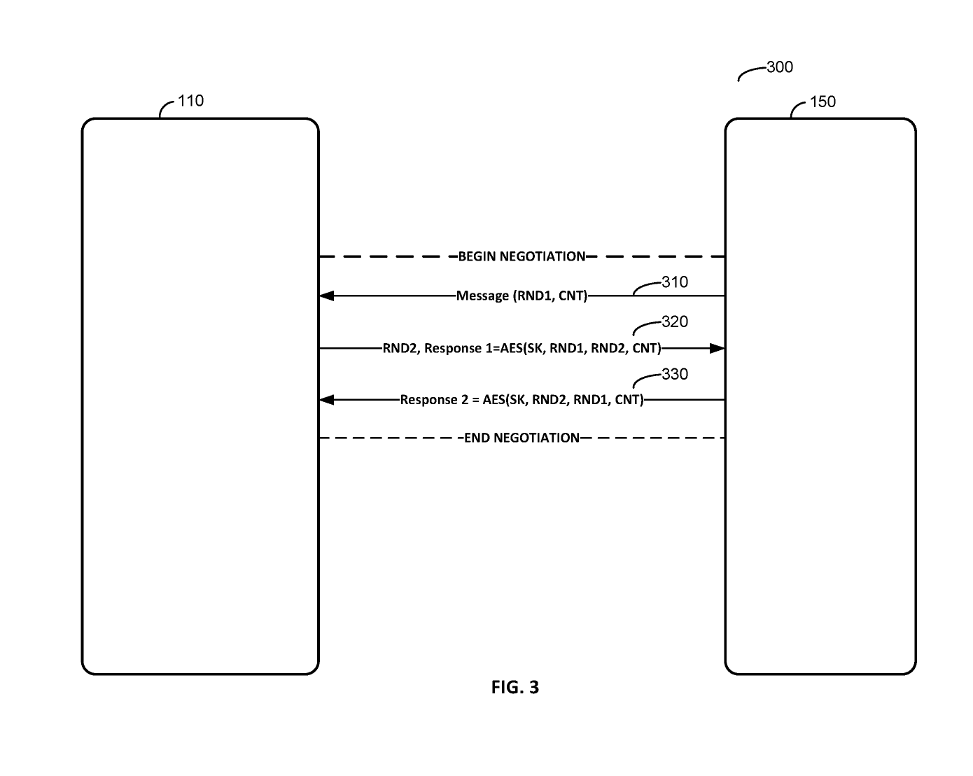

The NVM 150 can be configured to be a secure external non-volatile memory that can store the ARC value 165 and/or authentication keys, such as the secret key 160 which will be explained in greater detail below with respect to FIGS. 3-13. Because the NVM 150 is a secure NVM, the NVM 150 can be used to store the persistent ARC value 165, and the secure processing subsystem 110 does not require persistent memory to maintain a copy of the ARC value 165. The NVM 150 is referred to herein as a secure NVM, because the secure key 160 and/or other authentication keys used by the NVM 150 are stored within the NVM 150 such that the secure key 160 and/or other authentication keys cannot be extracted from the NVM 150 or modified by an external entity using logical or physical means. Furthermore, the ARC value 165 cannot be modified by an external entity.

Data can be exchanged between the secure processing subsystem 110 and the NVM 150 in an authenticated way that prevent replay/rollback attacks. The transactions conveying data can be authenticated using a secret key with which both the secure processing subsystem 110 and the NVM 150 have been provisioned. The secure processing subsystem 110 stores the secret key 130 in a persistent memory of the secure processing subsystem 110. The NVM 150 stores the secret key 160 in the non-volatile memory of the NVM 150. The secure processing subsystem 110 can also be configured to encrypt the data to be stored in the NVM 150 using an encryption key to which the NVM 150 does not have access. The secure processing subsystem 110 can also be configured to generate authentication tags that can be stored with the data to be written to the NVM 150 which can be used to confirm the integrity of the information. The NVM 150 may not have the key or keys used to generate the authentication tags, and thus, cannot alter the contents of the data stored in the NVM 150 without being detected by the secure processing subsystem 110.

The NVM 150 can be configured to provide a current ARC value 165 to the secure processing subsystem 110 at the time that the computing device 100 is booted or reset (or the secure processing subsystem 110 is booted or reset). The secure processing subsystem 110 can be configured to store this ARC value as ARC value 140 in the volatile memory 120 of the secure processing subsystem 110. The volatile memory 120 can comprise memory that is configured to maintain the data stored therein while power is provided to the volatile memory 120. The contents of the volatile memory 120 will be lost if the power supply to the secure processing subsystem 110 is lost.

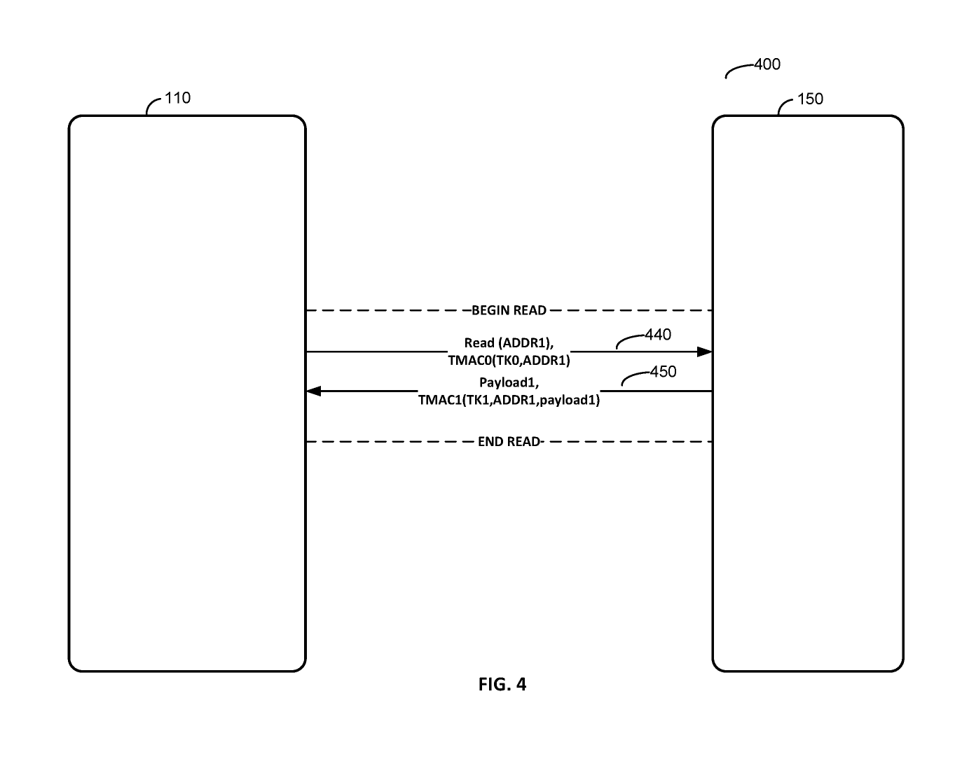

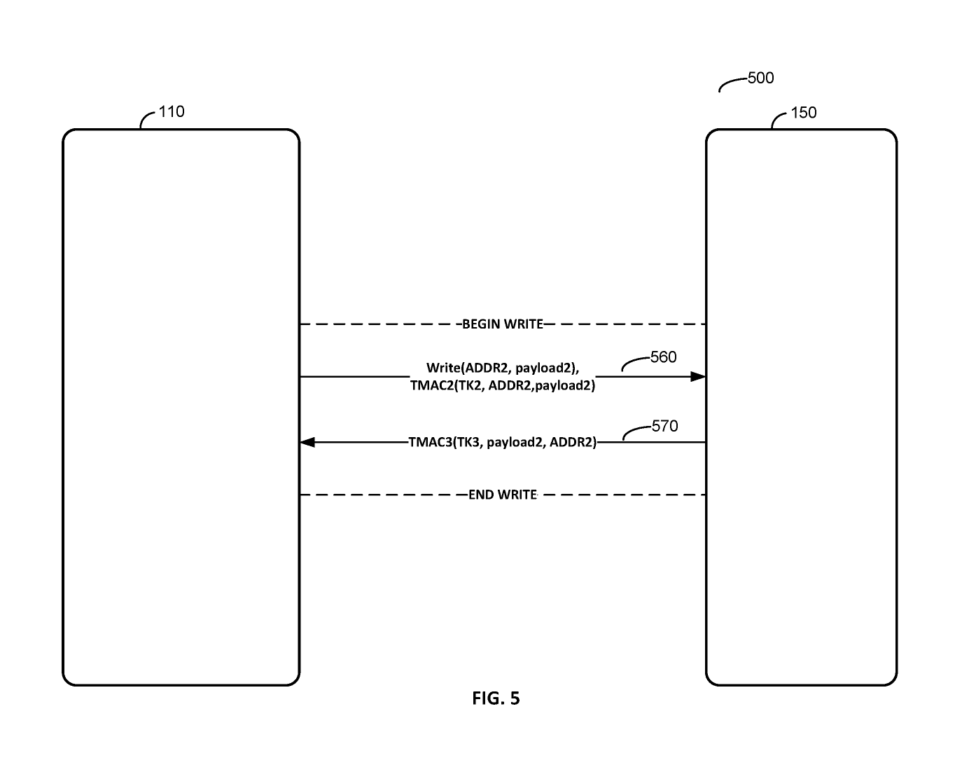

The secure processing subsystem 110 can be configured to write encrypted data to the NVM 150 for storage in the persistent memory of the NVM 150. The secure processing subsystem 110 can also be configured to read encrypted data from the NVM 150. FIGS. 4 and 5, which are described in detail below, illustrates examples of reading data from and writing data to the NVM 150.

The NVM 150 can comprise flash memory or other such non-volatile memory that can maintain the values stored therein should power to the NVM 150 be lost. The NVM 150 can be configured to operate as a “power island” within the computing device 100, meaning that the secure processing subsystem 110 and/or other components of the computing device 100 may be powered down to conserve power in a power source of the computing device 100 while the NVM 150 may remain powered. Components of the computing device 100, such as a main processor which may be used to implement the secure processing subsystem 110, a display, and/or other components of the computing device 100 may be powered down responsive to a power source of the computing device 100 reaching a threshold power level in order to conserve remaining power. The NVM 150 and one or more other components could remain powered up to allow the computing device 100 to perform limited computing tasks. For example, the NVM 150 and other components of the computing device 100 required to perform limited transactional tasks could remained powered up while the other components of the device are powered down. Transactions allowing limited purchasing and/or use of electronic tickets or other authorizations stored on the computing device 100 can be executed by the NVM 150 and other required components. For example, the computing device 100 may comprise a mobile phone, tablet, or wearable computing device which can be used to store electronic mass transit pass or purchase electronic tickets. The NVM 150 of the computing device 100 and other components of the device, such as one or more wireless transceivers may remain powered up to facilitate the purchase and/or use of the electronic transit pass stored on the computing device 100 or to execute a transaction to purchase said tickets or transit pass using financial information stored on the computing device 100. Other types of purchases (e.g. food, fuel, etc.) using the computing device 100. The computing device 100 can include a user interface that allows a user to configure the computing device 100 to enable such transactions and to impose limits on the amount, frequency, and/or locations at which such transactions may be undertaken while the computing device 100 is operating in the low power or substantially powered down state.

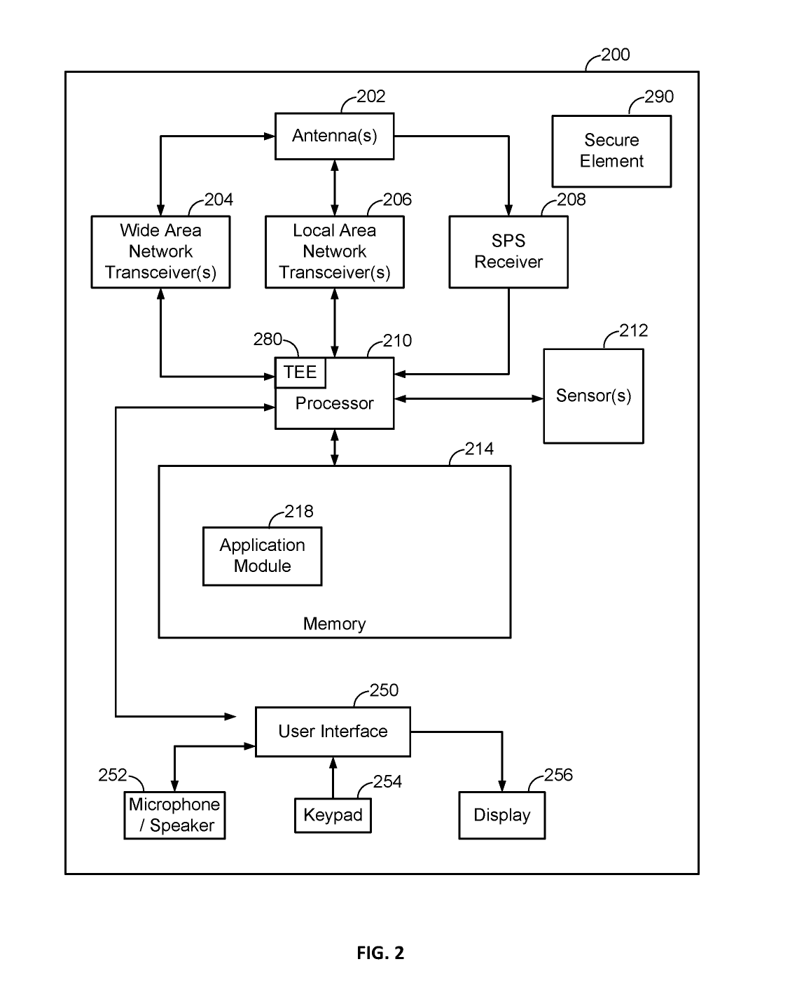

FIG. 2 is a functional block diagram of an example computing device 200 that can be used to implement the computing device 100 illustrated in FIG. 1. FIG. 2 is a schematic diagram illustrating various components of an example computing device 200, which may be similar to or the same as the computing device 100 depicted in FIG. 1. For the sake of simplicity, the various features/components/functions illustrated in the schematic boxes of FIG. 2 are connected together using a common bus to represent that these various features/components/functions are operatively coupled together. Other connections, mechanisms, features, functions, or the like, may be provided and adapted as necessary to operatively couple and configure a portable wireless device. Furthermore, one or more of the features or functions illustrated in the example of FIG. 2 may be further subdivided, or two or more of the features or functions illustrated in FIG. 2 may be combined. Additionally, one or more of the features or functions illustrated in FIG. 2 may be excluded.

As shown, the computing device 200 may include one or more local area network transceivers 206 that may be connected to one or more antennas 202. The one or more local area network transceivers 206 comprise suitable devices, circuits, hardware, and/or software for communicating with and/or detecting signals to/from one or more of the WLAN access points, and/or directly with other wireless devices within a network. In some embodiments, the local area network transceiver(s) 206 may comprise a WiFi (802.11x) communication transceiver suitable for communicating with one or more wireless access points; however, in some embodiments, the local area network transceiver(s) 206 may be configured to communicate with other types of local area networks, personal area networks (e.g., Bluetooth® wireless technology networks), etc. Additionally, any other type of wireless networking technologies may be used, for example, Ultra Wide Band, ZigBee, wireless USB, etc.

The computing device 200 may also include, in some implementations, one or more wide area network transceiver(s) 204 that may be connected to the one or more antennas 202. The wide area network transceiver 204 may comprise suitable devices, circuits, hardware, and/or software for communicating with and/or detecting signals from one or more of, for example, the WWAN access points and/or directly with other wireless devices within a network. In some implementations, the wide area network transceiver(s) 204 may comprise a CDMA communication system suitable for communicating with a CDMA network of wireless base stations. In some implementations, the wireless communication system may comprise other types of cellular telephony networks, such as, for example, TDMA, GSM, WCDMA, LTE etc. Additionally, any other type of wireless networking technologies may be used, including, for example, WiMax (802.16), etc.

In some embodiments, an SPS receiver (also referred to as a global navigation satellite system (GNSS) receiver) 208 may also be included with the computing device 200. The SPS receiver 208 may be connected to the one or more antennas 202 for receiving satellite signals. The SPS receiver 208 may comprise any suitable hardware and/or software for receiving and processing SPS signals. The SPS receiver 208 may request information as appropriate from the other systems, and may perform the computations necessary to determine the position of the computing device 200 using, in part, measurements obtained by any suitable SPS procedure.

As further illustrated in FIG. 2, the example computing device 200 includes one or more sensors 212 coupled to a controller/processor 210. For example, the sensors 212 may include motion sensors to provide relative movement and/or orientation information (which is independent of motion data derived from signals received by the wide area network transceiver(s) 204, the local area network transceiver(s) 206, and/or the SPS receiver 208). By way of example but not limitation, the motion sensors may include an accelerometer, a gyroscope, and a geomagnetic (magnetometer) sensor (e.g., a compass), any of which may be implemented based on micro-electro-mechanical-system (MEMS), or based on some other technology. The one or more sensors 212 may further include, a thermometer (e.g., a thermistor), an audio sensor (e.g., a microphone) and/or other sensors. The one or more sensors 212 may also include a camera (e.g., a charge-couple device (CCD)-type camera, a CMOS-based image sensor, etc.), which may produce still or moving images (e.g., a video sequence) that may be displayed on a user interface device, such as a display or a screen, and that may be further used to determine an ambient level of illumination and/or information related to colors and existence and levels of UV and/or infra-red illumination.

The processor(s) (also referred to as a controller) 210 may be connected to the local area network transceiver(s) 206, the wide area network transceiver(s) 204, the SPS receiver 208 and the one or more sensors 212. The processor may include one or more microprocessors, microcontrollers, and/or digital signal processors that provide processing functions, as well as other calculation and control functionality. The processor 210 may be coupled to storage media (e.g., memory) 214 for storing data and software instructions for executing programmed functionality within the mobile device. The memory 214 may be on-board the processor 210 (e.g., within the same IC package), and/or the memory may be external memory to the processor and functionally coupled over a data bus.

A number of software modules and data tables may reside in memory 214 and may be utilized by the processor 210 in order to manage both communications with remote devices/nodes, perform positioning determination functionality, and/or perform device control functionality. As illustrated in FIG. 2, in some embodiments, the memory 214 may include an application module 218 which can implement one or more applications. It is to be noted that the functionality of the modules and/or data structures may be combined, separated, and/or be structured in different ways depending upon the implementation of the computing device 200.

The application module 218 may be a process running on the processor 210 of the computing device 200, which may request position information from the positioning module 216 or other data from one of the other modules of the computing device 200. Applications typically run within an upper layer of the software architectures and may be implemented in a rich execution environment of the computing device 200, and may include indoor navigation applications, shopping applications, location aware service applications, etc.

The processor 210 may include a trusted execution environment 280 and/or the computing device 200 may include a secure element 290. The trusted execution environment 280 and/or the secure element 290 can be used to implement a secure processing environment for implementing the processes for executing a secure software module illustrated above. The trusted execution environment 280 can be implemented as a secure area of the processor 210 that can be used to process and store sensitive data in an environment that is segregated from the rich execution environment in which the operating system and/or applications (such as those of the application module 218) may be executed. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, anti-replay counter data, and/or other sensitive data.

The computing device 200 may include a secure element 290 (also referred to herein as a trusted component). The computing device 200 may include the secure element 290 in addition to or instead of the trusted execution environment 280. The secure element 290 can comprise autonomous and tamper-resistant hardware that can be used to execute secure applications and the confidential data associated with such applications. The secure element 290 can be used to store encryption keys, anti-replay counter data, and/or other sensitive data. The secure element 290 can comprise a Near Field Communication (NFC) tag, a Subscriber Identity Module (SIM) card, or other type of hardware device that can be used to securely store data. The secure element 290 can be integrated with the hardware of the computing device 200 in a permanent or semi-permanent fashion or may, in some implementations, be a removable component of the computing device 200 that can be used to securely store data and/or provide a secure execution environment for applications.

The computing device 200 may further include a user interface 250 providing suitable interface systems, such as a microphone/speaker 252, a keypad 254, and a display 256 that allows user interaction with the computing device 200. The microphone/speaker 252 (which may be the same or different from the audio sensor) provides for voice communication services (e.g., using the wide area network transceiver(s) 204 and/or the local area network transceiver(s) 206). The keypad 254 may comprise suitable buttons for user input. The display 256 may include a suitable display, such as, for example, a backlit LCD display, and may further include a touch screen display for additional user input modes.

FIG. 3 is an illustration of an example process 300 for negotiating between an external non-volatile memory (NVM) and a secure processing subsystem to establish an anti-replay counter according to the techniques disclosed herein. The process illustrated in FIG. 3 can be used to initialize an ARC value in the volatile memory 120 of the secure processing subsystem 110 based on an ARC value 165 maintained by the NVM 150. The NVM 150 maintains a persistent copy of the ARC value 165. When the secure processing subsystem 110 is rebooted, reset, or another event occurs where the volatile memory 120 of the secure processing subsystem 110 loses power, the ARC value 140 maintained in the volatile memory 120 of the secure processing subsystem 110 would be lost. However, the NVM 150 and the secure processing subsystem 110 can undertake a negotiation process, such as the example process illustrated in FIG. 3, to establish that the entities that are communicating are the secure processing subsystem 110 and the NVM 150 and not some other entity attempting to spoof the identity of the secure processing subsystem 110 or the NVM 150 and to securely establish the ARC value 140 in the volatile memory 120 of the secure processing subsystem 110 based on the ARC value 165 of the NVM 150.

The negotiation phase can begin with the NVM 150 sending a message to the secure processing subsystem 110 (stage 310). The NVM 150 can be configured to access the current ARC value 165 (represented by “CNT” parameter in the figure) and to send the ARC value 165 and a first randomly generated value (represented by the “RND1” parameter in the figure), which is also be referred to as a first nonce value herein, to the secure processing subsystem 110. The NVM 150 can also store the first nonce value in the persistent memory of the NVM 150. The first nonce value serves as a one-time value generated by the NVM 150 that is included with the message to the secure processing subsystem 110. The first nonce value can be included in subsequent messages received from the secure processing subsystem 110 during the negotiation phase and can be used to prevent a replay attack using previously exchanged messages.

The secure processing subsystem 110 can be configured to send a first response message to the NVM 150 in response to the message from the NVM 150 (stage 320). The first response message can include a second nonce value and a first cryptogram value. The secure processing subsystem 110 can be configured to extract the current ARC value from the message received from the NVM 150 and store the ARC value in the volatile memory 120 as ARC value 140. The secure processing subsystem can also be configured to store the first nonce value (RND1) in the volatile memory 120. The secure processing subsystem 110 can be configured to generate a second randomly generated value (represented by thee “RND2” parameter in the figure), also referred to herein as a second nonce value, and store the value of the RND2 in the volatile memory 120.

The secure processing subsystem 110 can be configured to generate a first cryptogram value to be send to the NVM 150 as part of the response to the message from the NVM 150. A cryptogram, as used herein, can refer to the output of an encryption algorithm that has been generated using a secret key (or a key derived therefrom) which is known to the secure processing subsystem 110 and the NVM 150. The first cryptogram value can be encrypted using the secret key 130 that has also been provided to the NVM 150 in advance. The secure processing subsystem 110 can be configured to use either the secret key 130 or can be configured to use a key derived from the secret key 130 using a key derivation function that accepts the current ARC value received from the NVM 150 as a parameter as the key used to generate the first cryptogram.

The secret keys may have been provided at the time that the secure processing subsystem 110 and the NVM 150 were manufactured or when they were integrated into the computing device 100. In other implementations, the secret keys may be deployed to the secure processing subsystem 110 and the NVM 150 using other means. The specific means for deploying the secret keys to the does not impact the techniques disclosed herein, and various secure means for deploying the secret keys may be used.

In the example illustrated in FIG. 3, the secure processing subsystem 110 and the NVM 150 are configured to use the Advanced Encryption Standard (AES) at least to generate the cryptogram values exchanged during the negotiation phase using either the secret key 130 or a key derived therefrom as discussed above. The secure processing subsystem 110 and the NVM 150 can be configured to use other types of encryption. The first randomly generated value (RND1), the second randomly generated value (RND2), and the current counter value (CNT) can be included in the first cryptogram value send with the first response message. Because these values have been encrypted using the secret key 130 of the secure processing subsystem 110, which should only be known to the secure processing subsystem 110 and the NVM 150, the NVM 150 can decrypt the first cryptogram value included with the first response messages to recover the RND1, RND2, and CNT values and to verify that the first response message was received from the secure processing subsystem 110.

The NVM 150 can be configured to send a second response message to the secure processing subsystem 110 responsive to the first response message (stage 330). The NVM 150 can be configured to send a second cryptogram value to the secure processing subsystem 110. The NVM 150 can be configured to use the secret key 160 or can be configured to use a key derived from the secret key 160 using a key derivation function that accepts the current ARC value 165 as a parameter as the key used to generate the second cryptogram value. The NVM 150 can be configured to use AES encryption or another type of encryption to generate the second cryptogram value. The NVM 150 can encrypt the second cryptogram value using the secret key 160 stored in the NVM 150. The first randomly generated value (RND1), the second randomly generated value (RND2), and the current counter value (CNT) can be included in the encrypted content of the second response message. As illustrated in the example illustrated in FIG. 3, the NVM 150 can be configured to permute the order of the parameters in the second cryptogram value compared to the order of the parameters in the first cryptogram value. For example, the order of the first randomly generated value (RND1) and the second randomly generated value (RND2) can be swapped in the second cryptogram value, which can be used to indicate that the NVM 150 successfully decrypted the first cryptogram value from the secure processing subsystem 110 and was not simply replaying the message received from the secure processing subsystem 110 that included the first cryptogram value. Upon receipt of the second response message from the NVM 150, the secure processing subsystem 110 can be configured to use the ARC value provided by the NVM 150 and now stored in the volatile memory 120 as ARC value 140.

Once the negotiation phase has completed, the identities of the secure processing subsystem 110 and the NVM 150 have been established and the counter value established in the volatile memory 120 of the secure processing subsystem 110. The secure processing subsystem 110 can then read and/or write data to the NVM 150 using the shared ARC value, which stored as ARC value 140 in the volatile memory 120. The secure processing subsystem 110 and the NVM 150 can be configured to increment the respective copies of the ARC value responsive to each read and/or write operation. Example processes illustrating such read and write operations are illustrated in FIGS. 4 and 5. The negotiation process illustrated in FIG. 3 may be repeated if power is lost to the computing device 100 or another event occurs where the contents of the volatile memory 120, including the ARC value 140, are lost or corrupted. The negotiation phase may be reinitiated by either the secure processing subsystem 110 or the NVM 150 responsive to a power loss or other event that causes the ARC value 140 to be lost from the volatile memory 120 or for the ARC value 140 and the ARC value 165 to become out of synchronization. For example, either the secure processing subsystem 110 or the NVM 150 may reinitialize the negotiation phase responsive to one or more messages between the secure processing subsystem 110 and the NVM 150 being removed, modified, and/or inserted by an attacker, which could potentially result in the loss of ARC synchronization between the secure processing subsystem 110 and the NVM 150.

FIG. 4 is a flow diagram of an example process for securing a read request using an anti-replay counter according to the techniques disclosed herein. The process illustrated in FIG. 4 can be implemented by the secure processing subsystem 110 and the NVM 150 once the negotiation phase to synchronize the ARC value 140 stored in the volatile memory of the secure processing subsystem with the ARC value 165 maintained by the NVM 150 has been completed. The process illustrated in FIG. 4 can be used to read data from the NVM 150 and provide the read data to the secure processing subsystem 110. The ARC values maintained by the secure processing subsystem 110 and the NVM 150 are kept synchronized throughout the read process and these ARC values can prevent replay attacks in which an attacker may attempt to replay one or more messages exchanged between the NVM 150 and the secure processing subsystem 110. The example process illustrated in FIG. 4 illustrates a single read being performed, but the secure processing subsystem 110 and the NVM 150 may participate in multiple read operations and/or write operations (such as those illustrated in FIG. 5) or a combination thereof once the negotiation phase has been completed and the ARC values of the secure processing subsystem 110 and the NVM 150 have been synchronized. The number of reads and/or writes can vary and the order in which such actions may be performed can also vary depending on the processing being performed by the secure processing subsystem 110 and the need to read from or write data to the NVM 150 as a result of such processing.

The secure processing subsystem 110 can send a read request message to the NVM 150 (stage 440). The read request message can include an address (ADDR1) representing an address of data that the secure processing subsystem 110 would like to have retrieved from the NVM 150. The read request may also include an optional size parameter (not shown) that can be used to indicate the size of the requested data to be read from the persistent memory of the NVM 150. The read message can be accompanied by a first transaction authentication value (also referred to herein as a “TMAC value” or a “transactional message authentication code”) (in stage 440 this is TMAC0) that can be used by the NVM 150 to verify that the read message has been issued by the secure processing subsystem 110. The TMAC value may be determined by computing a keyed-hash message authentication code (HMAC) of the ADDR1 value and a trusted key (TK) value. The trusted key value can be determined by a key derivation function which is provided the secret key 130 and the current ARC value 140 as parameters. The use of the TK value to generate the TMAC value can prevent an attacker that obtains the TMAC value from learning useful information about the secret key values maintained by the secure processing subsystem 110 and the NVM 150. Furthermore, the use of the current ARC value 140 in determining the trusted key value ensures that the message originates from the secure processing subsystem 110. While the techniques discussed herein use message authentication code techniques to generate the transaction authentication values, other techniques could be used to generate the transaction authentication values, such as cryptographic signature of at least a part of the ADDR1 or a digest of the ADDR1 value.

The NVM 150 can be configured to send a response to the read request to the secure processing subsystem 110 (stage 450). The NVM 150 can be configured to determine that the read message was sent by the secure processing subsystem 110 based on the first transaction authentication value (the TMAC0 value) and the ADDR1 parameter of the read request. The NVM 150 can compute a local first transaction authentication value (referred to as “TMAC0-0 value” for stage 450) based on the ADDR1 value and secret key 160 using the same technique that the secure processing subsystem 110 used to compute the TMAC0 value. The NVM 150 can pass the secret key 160 to the key derivation function with the current ARC value 165 as a parameter in order to obtain the trusted key value. The trusted key value can then be used to generate the TMAC0-0 value by applying the same cryptographic algorithm applied by the secure processing subsystem 110 to the ADDR1 parameter using the trusted key derived by the NVM 150. The NVM 150 can then compare the TMAC0 and the TMAC0-0 values to determine if the values are the same. If the values do not match, then the NVM 150 can be configured to ignore the read request or take some other action as the read request may not have originated from the secure processing subsystem 110 and/or may be a replay attack that used an old ARC value.

The NVM 150 can be configured to read the payload value stored at address ADDR1 from the persistent memory of the NVM 150 responsive to the TMAC0 and the TMAC0-0 values matching and to provide the payload value to the secure processing subsystem in a response to the read request. The payload comprises encrypted data that was stored in the NVM 150. The payload may be associated with an authentication tag, such as a MAC value, that is computed by the secure processing subsystem 110 prior to the encrypted payload being written to the NVM 150, and the authentication tag can be read with the payload data and provided to the secure processing subsystem 110 with the payload data. The secure processing subsystem 110 may have provided the payload and the authentication tag (if any) to the NVM 150 via a write request, such as that illustrated in FIG. 5.

The authentication tag can be computed using a key that is different than the secret key 130 of the secure processing subsystem which is shared with the NVM 150. Furthermore, the payload can be encrypted by the secure processing subsystem 110 using a key that is different than the secret key 130 of the secure processing subsystem which is shared with the NVM 150. Using a different key or keys to encrypt and/or to encrypt the payload and/or to generate the authentication tag allows the secure processing subsystem to be able decrypt the encrypted payload data and to determine whether the encrypted payload has been altered since the authentication tag was generated. The NVM 150 is not provided with these keys used to encrypt the payload and/or to generate the authentication tag. Thus, the NVM 150 does not have the ability to decrypt the data to generate a new authentication tag for the payload data.

The NVM 150 can determine a second transaction authentication value (in this example TMAC1), which will accompany the payload data and the authentication tag (if any) being provided to the secure processing subsystem 110. The TMAC1 value may be determined by computing a HMAC of the payload1, the address provided in the read request, and a TK value determined using a technique similar to that used by the secure processing subsystem 110 to determine the TK value used to determine the TMAC0 value. The TK value can be determined by a key derivation function technique, such as that discussed above, in which the key derivation function is provided the secret key 130 and the current ARC value 140 as parameters.

The secure processing subsystem 110 can be configured to verify that the payload1 was received from the NVM 150 and is not part of a replay attack. The secure processing subsystem 110 can be configured to calculate a local second transaction authentication value (TMAC1-1) based on the address from the read request, the payload1 data, and TK value, using the same techniques that the NVM 150 used to calculate the TMAC1 value and the secret key 130 or a key derived therefrom. The secure processing subsystem 110 can be configured to derive a trusted key from the secret key 130 using a key derivation function that accepts the secret key 130 and the current ARC value 140 stored in the volatile memory of the secure processing subsystem 110. The TMAC1-1 can be derived by the secure processing subsystem by applying the same cryptographic algorithm that the NVM 150 applied to calculate the TMAC1 value. The secure processing subsystem 110 can be configured to compute a HMAC of the payload1 value using the trusted key.

The secure processing subsystem 110 can be configured to compare the received second transaction authentication value (TMAC1) and the locally computed second transaction authentication value (TMAC1-1). If the two values do not match, the secure processing subsystem 110 can be configured to reject the payload1 and may be configured to perform other task responsive to the possible replay attack, including sending a message to the NVM 150 and/or to other components of the computing device 100.

The secure processing subsystem 110 and the NVM 150 can be configured to increment the ARC value 140 and the ARC value 165 respectively. The NVM 150 can be configured to increment the ARC value 165 following stage 450 of the process illustrated in FIG. 4 after sending the requested data is provided to the secure processing subsystem 110. The secure processing subsystem 110 can be configured to update the ARC value 140 upon receipt of the message from the NVM 150 in stage 450 and verifying that the message was received from the NVM 150 as discussed above.

FIG. 5 is a flow diagram of an example process for securing a write request using an anti-replay counter according to the techniques disclosed herein. The process illustrated in FIG. 5 can be implemented by the secure processing subsystem 110 and the NVM 150 once the negotiation phase to synchronize the ARC value 140 stored in the volatile memory of the secure processing subsystem with the ARC value 165 maintained by the NVM 150 has been completed. The process illustrated in FIG. 5 can be used write data from the secure processing subsystem 110 to the NVM 150. The ARC values maintained by the secure processing subsystem 110 and the NVM 150 are kept synchronized throughout the write process and these ARC values can prevent replay attacks in which an attacker may attempt to replay one or more messages exchanged between the NVM 150 and the secure processing subsystem 110. The example process illustrated in FIG. 5 illustrates a single write being performed, but the secure processing subsystem 110 and the NVM 150 may participate in multiple read operations (such as those illustrated in FIG. 4) and/or write operations (such as those illustrated in FIG. 5) or a combination thereof once the negotiation phase has been completed and the ARC values of the secure processing subsystem 110 and the NVM 150 have been synchronized. The number of reads and/or writes can vary and the order in which such actions may be performed can also vary depending on the processing being performed by the secure processing subsystem 110 and the need to read from or write data to the NVM 150 as a result of such processing.

The secure processing subsystem 110 can send a write request message to the NVM 150 (stage 560). The parameters of the write message can include an address in the NVM 150 (ADDR2 in this example) to which the payload data (payload2 in this example) is to be written. The write request can also include a first transaction authentication value (in stage 560 this is “TMAC2”) which has been computed based on the payload2 and/or the ADDR2 values using the techniques discussed above for calculating a transaction authentication value by the secure processing subsystem 110 using the secret key 130.

The first transaction authentication value (the TMAC2 value) can be determined by computing a keyed-hash message authentication code (HMAC) of the ADDR2 value, the payload2 data, and a trusted key (TK) value. The trusted key value can be determined by a key derivation function which is provided the secret key 130 and the current ARC value 140 as parameters. The use of the TK value to generate the TMAC2 value can prevent an attacker that obtains the TMAC2 value from learning useful information about the secret key values maintained by the secure processing subsystem 110 and the NVM 150. While the techniques discussed herein use message authentication code techniques to generate the transaction authentication values, other techniques could be used to generate the transaction authentication values, such as cryptographic a cryptographic signature of at least a part of the ADDR2 and/or the payload2 or a digest of the ADDR1 value and/or the payload2.

The NVM 150 can be configured to verify that the write request originated from the secure processing subsystem 110 using the TMAC2 value as discussed above by determining a local first transaction authentication value (TMAC 2-1). The local first authentication transaction value (the TMAC2-1 value) may be determined by computing a keyed-hash message authentication code (HMAC) of the ADDR2 value, the payload2 data, and a trusted key (TK) value. The trusted key value can be determined by a key derivation function which is provided the secret key 160 and the current ARC value 165 as parameters.

If the TMAC2 and the TMAC2-1 value match, this indicates that the write request originated from the secure processing subsystem 110 and used the correct ARC value. The NVM 150 can be configured to write the payload data (which may comprise encrypted data and an associated MAC value) to the address in the NVM 150 indicated by ADDR2 responsive to the write request being valid. If the TMAC2 and TMAC 2-1 values do not match, this is indicative of the write request not originating from the secure processing subsystem 110 or an incorrect ARC value was used. The NVM 150 can be configured to reject the write request and may be configured to notify the secure processing subsystem 110 and/or other components of the computing device 100 responsive to the transaction authentication value and the local transaction authentication value not matching.

The NVM 150 can be configured to send a response message to the secure processing subsystem responsive to receiving the write request message (stage 570). The response message comprise a second transaction authentication value (TMAC3 in stage 570), which can be computed using the trusted key determined by a key derivation function which is provided the secret key 160 and the current ARC value 165 as parameters, the payload2 value, and the ADDR2 value. The order of the parameters used to compute the TMAC3 value can be permuted so that they differ from the order of the parameters in the TMAC2 value. For example, the order of the payload2 value and the ADDR2 value parameters can be swapped when determining the TMAC3 value, which can be used to indicate that the NVM 150 successfully decrypted the TMAC2 value from the secure processing subsystem 110 and was not simply replaying the message received from the secure processing subsystem 110 that included the TMAC2 value. The secure processing subsystem 110 can be configured to authenticate the response message using the second transaction authentication value by computing a local second transaction authentication value. The local second transaction authentication value can be computed by the secure processing subsystem 110 using the same technique used by the NVM 150 and providing the current ARC value 140, the payload2 value, and the ADDR2 value as parameters.

The secure processing subsystem 110 and the NVM 150 can be configured to increment the ARC value 140 and the ARC value 165 respectively. The NVM 150 can be configured to increment the ARC value 165 following stage 570 of the process illustrated in FIG. 5 upon sending the requested data is provided to the secure processing subsystem 110. The secure processing subsystem 110 can be configured to update the ARC value 140 upon receipt of the message from the NVM 150 in stage 450 and verifying that the message was received from the NVM 150 as discussed above.

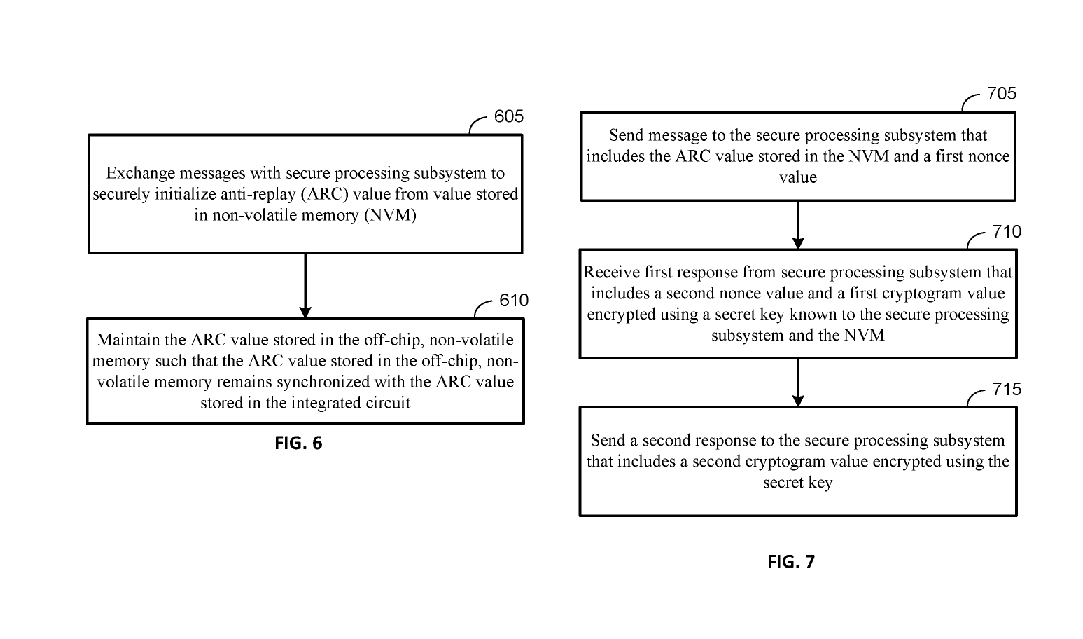

FIG. 6 is a flow diagram of an example process for maintaining an anti-replay counter according to the techniques disclosed herein. The process illustrated in FIG. 6 can be implemented by the NVM 150.

Messages can be exchanged with the secure processing subsystem 110 to securely initialize an ARC value 140 in the secure processing subsystem 110 from an ARC value 165 stored in the NVM 150 (stage 605). During the initialization process, the NVM 150 can provide the ARC value 165 to the secure processing subsystem 110 to enable the secure processing subsystem 110 to initialize the value of the ARC value 140 stored therein. During the initialization process, the NVM 150 and the secure processing subsystem 110 can exchange information encrypted using a shared secret key known to the NVM 150 and the secure processing subsystem 110 to authenticate that the messages purported to be from the NVM 150 are actually from the NVM 150 and messages purported to be from the secure processing subsystem 110 are actually from the secure processing subsystem 110. Stage 605 can be implemented according to the process illustrated in FIG. 3.

The ARC value 165 in the NVM 150 is kept synchronized with the ARC value 140 maintained by the secure processing subsystem 110 (stage 610). Once the respective ARC values of the NVM 150 and the secure processing subsystem 110 have been synchronized, the NVM 150 and the secure processing subsystem 110 can be configured to keep their respective ARC values synchronized. For example, the NVM 150 can be configured to increment the ARC value 165 after each successful read request or write request. Examples of such synchronization are discussed above with respect to the processes illustrated in FIGS. 4 and 5. The ARC value 165 and the ARC value 140 are each incremented for each transaction, such as a read request or a write request, that occurs.

FIG. 7 is a flow diagram of an example process negotiating with a secure processing subsystem to establish an anti-replay counter according to the techniques disclosed herein. The process illustrated in FIG. 7 can be implemented by the NVM 150.

A message can be sent to the secure processing subsystem 110 that includes the ARC value stored in the NVM and a first nonce value (stage 705). The message can be similar to that sent in stage 310 of the process illustrated in FIG. 3. The NVM 150 can be configured to send the message to the secure processing subsystem in response to the secure processing subsystem 110 being powered up or rebooted, which would cause the ARC value 140 stored in the volatile memory 120 of the secure processing subsystem to be lost.

A first response message can be received from secure processing subsystem 110 that includes a second nonce value and a first cryptogram value encrypted using a secret key known to the secure processing subsystem and the NVM 150 (stage 710). The secure processing subsystem 110 can send a response message to the NVM 150 that is similar to the response message sent in stage 320 of the process illustrated in FIG. 3. The response message includes information encrypted using the secret key 130 of the secure processing subsystem 110 (referred to herein as the first cryptogram). The NVM 150 includes a copy of the secret key 160 that can be used to decrypt the first cryptogram, and can use information included in the first cryptogram value to verify that the response message was received from the secure processing subsystem 110 and that the message is not merely a replay of a previously sent message based on an ARC value included in the first cryptogram value. The NVM 150 can be configured to halt the negotiation process and can be configured to notify the secure processing subsystem 110 and/or other components of the computing device 100 responsive to the first cryptogram value not including the ARC value and the nonce value provided to the secure processing subsystem 110 in stage 705.

A second response message can be sent to the secure processing subsystem that includes a second cryptogram value encrypted using the secret key (stage 715). The NVM 150 can send a second response message to the secure processing subsystem 110 that is similar to the response message sent in stage 330 of the process illustrated in FIG. 3. The second cryptogram included with the second response message verifies to the secure processing subsystem 110 that the NVM 150 received and successfully decrypted the first cryptogram value and was not merely a replay of a previously sent message.

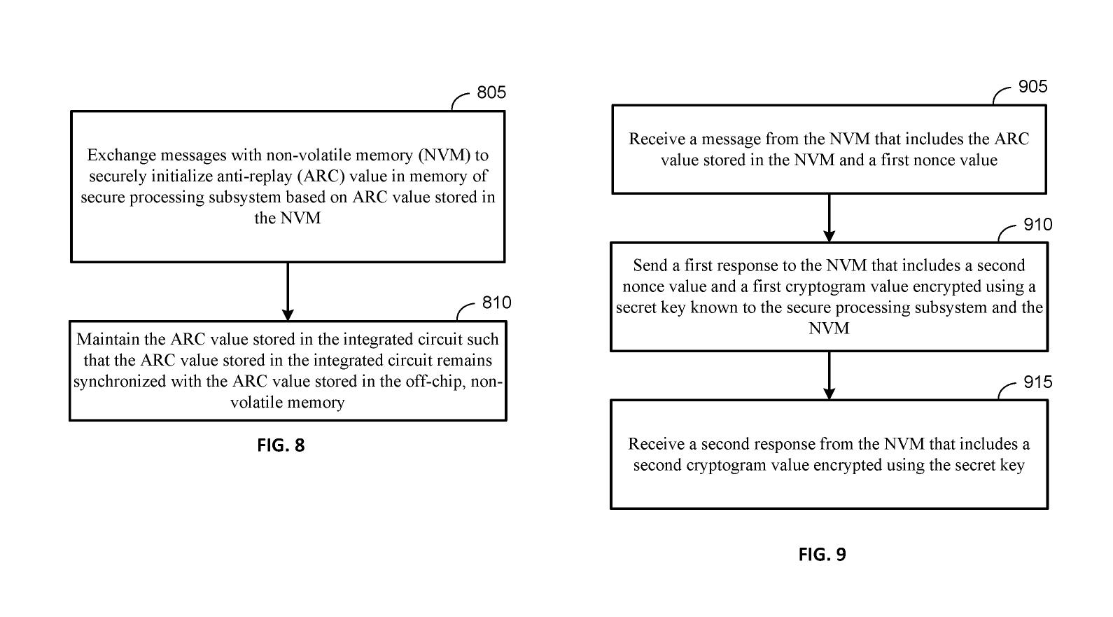

FIG. 8 is a flow diagram of an example process for maintaining an anti-replay counter according to the techniques disclosed herein. The process illustrated in FIG. 8 can be implemented by the secure processing subsystem 110.

Messages can be exchanged with the secure processing subsystem 110 to securely initialize an ARC value 140 in the secure processing subsystem 110 from an ARC value 165 stored in the NVM 150 (stage 805). During the initialization process, the NVM 150 can provide the ARC value 165 to the secure processing subsystem 110 to enable the secure processing subsystem 110 to initialize the value of the ARC value 140 stored therein. During the initialization process, the NVM 150 and the secure processing subsystem 110 can exchange information encrypted using a shared secret key known to the NVM 150 and the secure processing subsystem 110 to authenticate that the messages purported to be from the NVM 150 are actually from the NVM 150 and messages purported to be from the secure processing subsystem 110 are actually from the secure processing subsystem 110. Stage 605 can be implemented according to the process illustrated in FIG. 3.

The ARC value 165 in the secure processing subsystem is kept synchronized with the ARC value 140 maintained by the NVM 150 (stage 810). Once the respective ARC values of the NVM 150 and the secure processing subsystem 110 have been synchronized, the NVM 150 and the secure processing subsystem 110 can be configured to keep their respective ARC values synchronized. For example, the secure processing subsystem 110 can be configured to increment the ARC value 140 after each successful read request or write request. Examples of such synchronization are discussed above with respect to the processes illustrated in FIGS. 4 and 5. The ARC value 165 and the ARC value 140 are each incremented for each transaction, such as a read request or a write request, that occurs.

FIG. 9 is a flow diagram of an example process negotiating with a non-volatile memory to establish an anti-replay counter according to the techniques disclosed herein. The process illustrated in FIG. 9 can be implemented by the secure processing subsystem 110 and the NVM 150.

A message can be sent by the NVM 150 to the secure processing subsystem 110 that includes the ARC value stored in the NVM 150 and a first nonce value (stage 905). The message can be similar to that sent in stage 310 of the process illustrated in FIG. 3. The NVM 150 can be configured to send the message to the secure processing subsystem in response to the secure processing subsystem 110 being powered up or rebooted, which would cause the ARC value 140 stored in the volatile memory 120 of the secure processing subsystem to be lost. The secure processing subsystem 110 can be configured to extract the current ARC value from the message received from the NVM 150 and store the ARC value in the volatile memory 120 as ARC value 140. The secure processing subsystem can also be configured to store the first nonce value in the volatile memory 120.

A first response message can be sent by the secure processing subsystem 110 to the NVM 150 that includes a second nonce value and a first cryptogram value encrypted using a secret key known to the secure processing subsystem and the NVM 150 (stage 910). The secure processing subsystem 110 can be configured to generate a second randomly generated value, also referred to herein as a second nonce value, and store the value of the second nonce value in the volatile memory 120. The secure processing subsystem 110 can send a response message to the NVM 150 that is similar to the response message sent in stage 320 of the process illustrated in FIG. 3. The response message includes information encrypted using the secret key 130 of the secure processing subsystem 110 (referred to herein as the first cryptogram).

A second response message from the NVM 150 can be received by the secure processing subsystem 110 that includes a second cryptogram value encrypted using the secret key (stage 915). The NVM 150 can send a second response message to the secure processing subsystem 110 that is similar to the response message sent in stage 330 of the process illustrated in FIG. 3. The second cryptogram included with the second response message verifies to the secure processing subsystem 110 that the NVM 150 received and successfully decrypted the first cryptogram value and was not merely a replay of a previously sent message. The secure processing subsystem 110 can be configured to halt the negotiation process and can be configured to notify the NVM 150 and/or other components of the computing device 100 responsive to the second cryptogram value not including the ARC value and the first and second nonce values.

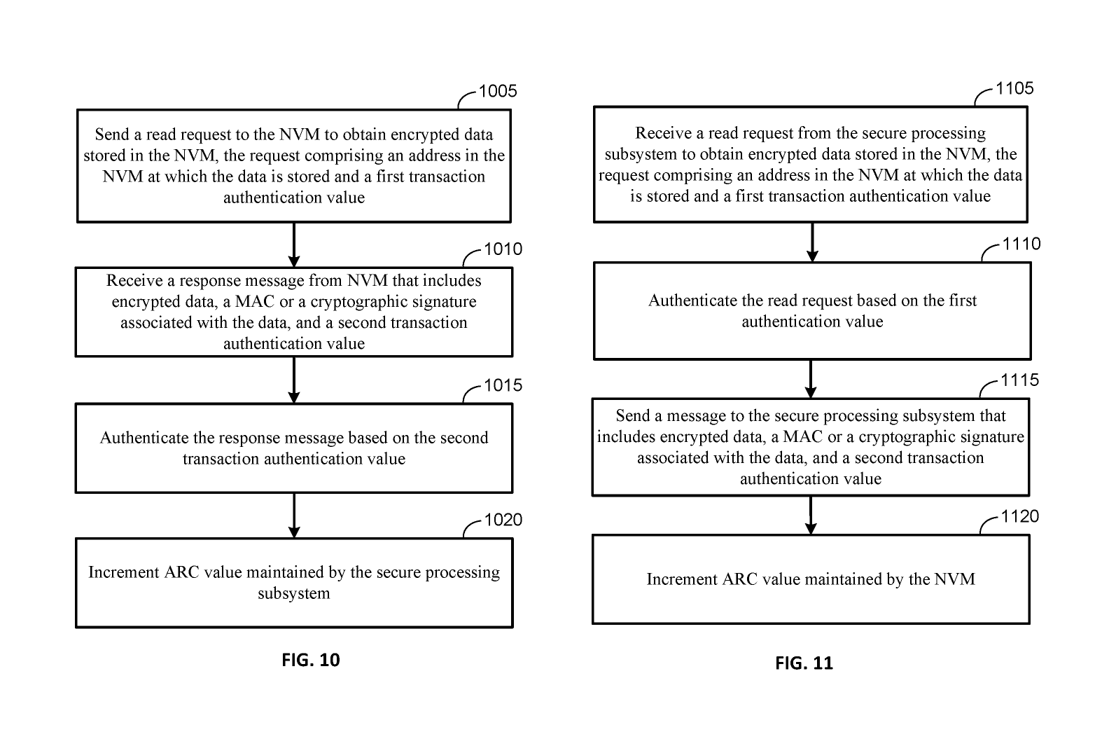

FIG. 10 is a flow diagram of an example process for securing a read request using an anti-replay counter according to the techniques disclosed herein. The process illustrated in FIG. 10 can be implemented by the secure processing subsystem 110.

The secure processing subsystem 110 can send a read request to the NVM 150 to obtain encrypted data stored in the NVM 150 (stage 1005). The request can include an address value representing an address in the NVM 150 at which the data is stored and a first transaction authentication value. The message can be similar to the message sent in stage 440 of the process illustrated in FIG. 4, and the first transaction authentication value can be computed using a technique similar to that used to compute the first transaction authentication value in stage 440 of FIG. 4. The first transaction authentication value includes information that the NVM 150 can used to authenticate the read request to ensure that the read request is being sent by the secure processing subsystem 110. The first transaction authentication value can comprise a cryptographic value computed based on the address value and using an encryption key associated with the secure processing subsystem 110. The key used to generate the first transaction authentication value can be derived from the secret key 130 of the secure processing subsystem 110, and may be derived using a technique similar to that discussed above with respect to stage 440 of FIG. 4. The first transaction authentication value can be determined by the secure processing subsystem 110 by applying a cryptographic algorithm to the address value associated with the read request from stage 1005. For example, the first transaction authentication value can comprise a message authentication code that can be used by NVM 150 to confirm that the read request came from the secure processing subsystem 110 and that the read request was not modified during transit.

The secure processing subsystem 110 can receive a response message from the NVM 150 that includes encrypted data, an authentication tag comprising a MAC or cryptographic signature associated with the data, and a second transaction authentication value (stage 1010). The message can be similar to the message sent in stage 450 of the process illustrated in FIG. 4, and the second transaction authentication value can be computed using a technique similar to that used to compute the second transaction authentication value in stage 450 of FIG. 4. The inclusion of the authentication tag is optional, and some implementations of the secure processing subsystem 110 may not be configured to store the encrypted data in the NVM 150 with such an authentication tag. The message received from the NVM 150 can be similar to the message sent in stage 450 of the process illustrated in FIG. 4. The second transaction authentication value can comprise a cryptographic value computed based on the address value and using an encryption key associated with the NVM 150 that is also known to the secure processing subsystem, such as the secret key 160 of the NVM 150 or a key derived therefrom. The encryption key used to generate the second transaction authentication value and may be derived using a technique similar to that discussed above with respect to stage 450 of FIG. 4.

The response message can be authenticated based on the second transaction authentication value (stage 1015). The secure processing subsystem 110 can be configured to compute a local second transaction value and to compare the local second transaction authentication value with the second transaction value to ensure that these values match. The local second transaction authentication value can be computed using a technique similar to that used in stage 450 of the process illustrated in FIG. 4. The secure processing subsystem 110 can be configured to derive a trusted key from the secret key 130 based on a current value of the ARC value 140 using a key derivation function. A cryptographic function can be applied to the address value received in the read request and the encrypted data, which may or may not include an authentication tag, using the trusted key to generate the second authentication value. The secure processing subsystem 110 can be configured to use the second transaction authentication value to confirm that the response message originated from the NVM 150 and was not a replay of a previous message since the ARC counter is used to generate the value. The secure processing subsystem 110 can be configured to ignore the response message and/or to take other actions in response to the local second transaction authentication value and the second transaction authentication value not matching.

The secure processing subsystem 110 can determine that the response message originated from the NVM 150 by calculating a local version of the second transaction authentication value. The second transaction authentication value can be determined by the NVM 150 by applying a cryptographic algorithm to the address value associated with the read request from stage 1005 and the encrypted data (also referred to as the payload) which may include also include an authentication tag associated with the encrypted data. For example, the second transaction authentication value can comprise a message authentication code that can be used by the secure processing subsystem 110 to confirm that the response message came from the NVM 150 and was not modified during transit. The secure processing subsystem 110 can be configured to determine the local copy of the second transaction authentication value using the secret key 130 or a key derived from the secret key 130, the address associated with the request from stage 1005, and the encrypted data received from in stage 1010. The locally determined second transaction authentication value determined ins stage 1015 should match the second transaction authentication value received from the NVM 150. If the two values do not match, the data received in stage 1010 can be discarded, and the secure processing subsystem 110 can be configured to take one or more actions in response to the mismatch. If the two values do match, the secure processing subsystem 110 can be configured to decrypt the encrypted data received in stage 1010 for further processing, and can be configured to proceed to stage 1020 where the ARC value 140 stored in the volatile memory 120 can be incremented. The response message may indicate that the read request could not be completed for some reason other than a transaction authentication value mismatch. The response message can inform the secure processing subsystem 110 of the error. However, both the NVM 150 and the secure processing subsystem 110 can be configured to increment their respective ARC values even though the read request could not be completed to prevent replay attacks.

The secure processing subsystem 110 can be configured to increment the ARC value 140 responsive to authenticating the response message received from the NVM 150 (stage 1020). The secure processing subsystem 110 can be configured to increment the ARC value 140 stored in the volatile memory of the secure processing subsystem once the response message has been determined to have originated from the NVM 150.

FIG. 11 is a flow diagram of an example process for securing a read request using an anti-replay counter according to the techniques disclosed herein. The process illustrated in FIG. 11 can be implemented by the NVM 150.

A read request for encrypted data stored in the NVM 150 can be received from the secure processing subsystem 110 at the NVM requesting (stage 1105). The request can include an address value representing an address in the NVM 150 at which the data is stored and a first transaction authentication value. The request can include an address value representing an address in the NVM 150 at which the data is stored and a first transaction authentication value. The message can be similar to the message sent in stage 440 of the process illustrated in FIG. 4, and the first transaction authentication value can be computed using a technique similar to that used to compute the TMAC in stage 440 of FIG. 4. The first transaction authentication value includes information that the NVM 150 can used to authenticate the read request to ensure that the read request is being sent by the secure processing subsystem 110. The first transaction authentication value can comprise a cryptographic value computed based on the address value and using an encryption key associated with the secure processing subsystem 110. The key used to generate the first transaction authentication value can be derived from the secret key 130 of the secure processing subsystem 110 based on a current value of the ARC value 140 stored in the volatile memory 120 of the secure processing subsystem 110, and may be derived using a technique similar to that discussed above with respect to stage 440 of FIG. 4. The first transaction authentication value can be determined by the secure processing subsystem 110 by applying a cryptographic algorithm to the address value associated with the read request from stage 1005 and the trusted key derived from the secret key 130. For example, the first transaction authentication value can comprise a message authentication code that can be used by NVM 150 to confirm that the read request came from the secure processing subsystem 110 and that the read request was not modified during transit.

The read request can be authenticated based on the first authentication value (stage 1110). The NVM 150 can be configured to compute a local first transaction value and to compare the local first transaction authentication value with the first transaction value to ensure that these values match. The local first transaction value can be computed using a technique similar to the technique used to calculate the TMAC values discussed above with respect to stage 450 of FIG. 4. The NVM 150 can be configured to derive a trusted key from the secret key 160 based on a current value of the ARC value 165 using a key derivation function. A cryptographic function can be applied to the address value received in the read request using the trusted key to generate the local first authentication value. The NVM 150 can be configured to ignore the read request and/or to take other actions in response to the local first transaction authentication value and the first transaction authentication value not matching.

The NVM 150 can send a response message from the NVM 150 that includes encrypted data, an authentication tag comprising a MAC or cryptographic signature associated with the data, and a second transaction authentication value to the secure processing subsystem 110 (stage 1115). The inclusion of the authentication tag is optional, and some implementations of the secure processing subsystem 110 may not be configured to store the encrypted data in the NVM 150 with such an authentication tag. The message sent from the NVM 150 can be similar to the message sent in stage 450 of the process illustrated in FIG. 4, and the second transaction authentication value can be computing using a technique similar to that discussed with respect to stage 450 of FIG. 4. The second transaction authentication value can comprise a cryptographic value computed based on the address value and using an encryption key associated with the NVM 150 that is also known to the secure processing subsystem, such as the secret key 160 of the NVM 150 or a key derived therefrom. The encryption key used to generate the second transaction authentication value and may be derived using a technique similar to that discussed above with respect to stage 450 of FIG. 4. The NVM 150 can be configured to derive a trusted key from the secret key 160 based on a current value of the ARC value 165 using a key derivation function. A cryptographic function can be applied to the address value received in the read request and the encrypted data, which may or may not include an authentication tag, using the trusted key to generate the second authentication value. The secure processing subsystem 110 can be configured to use the second transaction authentication value to confirm that the response message originated from the NVM 150 and was not a replay of a previous message since the ARC counter is used to generate the value. The response message may indicate that the read request could not be completed for some reason other than a transaction authentication value mismatch. The response message can inform the secure processing subsystem 110 of the error. However, both the NVM 150 and the secure processing subsystem 110 can be configured to increment their respective ARC values even though the read request could not be completed to prevent replay attacks.

The NVM 150 can be configured to increment the ARC value 165 responsive to sending the response message to the secure processing subsystem 110 (stage 1120). The NVM 150 can be configured to increment the ARC value 165 maintained by the NVM 150 once the NVM 150 has authenticated the read request from the secure processing subsystem 110 and has send the response message comprising the requested data to the secure processing subsystem 110. The NVM 150 can also be configured to increment the ARC value 165 prior to sending the response message confirming to the secure processing subsystem 110.

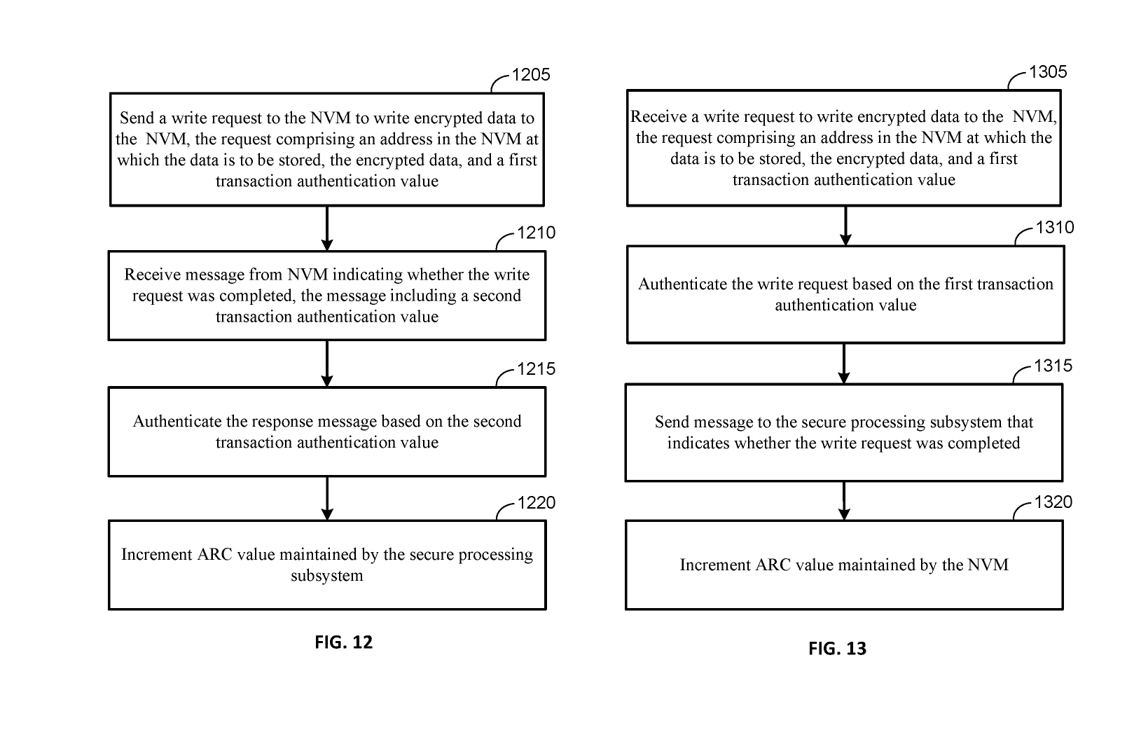

FIG. 12 is a flow diagram of an example process for securing a write request using an anti-replay counter according to the techniques disclosed herein. The process illustrated in FIG. 12 can be implemented by the secure processing subsystem 110.

A write request can be sent to the NVM 150 to write encrypted data to the NVM 150 (stage 1205). The write request may be similar to the write request message illustrated in stage 560 of the example process of FIG. 5, and the first transaction authentication value can be computed using a technique similar to that discussed above with respect to stage 560 of the process of FIG. 5. The request can include an address in the NVM 150 at which the data is to be stored, the encrypted data to be stored in the NVM 150 (which may include an authentication tag), and a first transaction authentication value. The data may be encrypted by the secure processing subsystem 110 and/or the authentication tag (if any) may be generated using one or more keys that are maintained in secret by the secure processing subsystem 110. The NVM 150 may not have access to these one or more keys, and thus, may not be able to decrypt the encrypted and/or regenerate the authentication tag. The first transaction authentication value can be determined by the secure processing subsystem 110 by applying a cryptographic algorithm to the address value associated with the write request and the encrypted data (also referred to as the payload) and the authentication tag associated with the encrypted data (if any). The first authentication value can comprise a message authentication code, which may be generated using a trusted key derived from the secret key 130 using a key derivation function that accepts the current ARC value 140 as a parameter.

A response message can be received from the NVM 150 indicating whether the write request was completed (stage 1210). The response message can include a second transaction authentication value. The response message may be similar to the response message illustrated in stage 570 of the example process of FIG. 5, and the second transaction authentication value can be computed using a technique similar to that discussed above with respect to stage 570 of the process of FIG. 5. The second transaction authentication value can be determined by the NVM 150 by applying a cryptographic algorithm to the address value and/or the encrypted data send in stage 1205. The second authentication value can comprise a message authentication code, which may be generated using a trusted key derived from the secret key 160 using a key derivation function that accepts the current ARC value 165 as a parameter. The NVM can be configured to permute the order of the address and the encrypted data when determining the second authentication value, so that first and second authentication values differ and the second authentication value is not merely a replay of the first authentication value sent with the write request in stage 1205.

The response message received from the NVM 150 can be authenticated using the second transaction authentication value (stage 1215). The secure processing subsystem can be configured to generate a local second transaction authentication value by applying the same cryptographic algorithm to the address value and/or the encrypted data sent in stage 1205. The local second authentication value can comprise a message authentication code, which may be generated using a trusted key derived from the secret key 130 using a key derivation function that accepts the current ARC value 140 as a parameter. The secure processing subsystem 110 can be configured to halt the write process responsive to the local second transaction authentication value not matching the second transaction authentication value received from the NVM 150. The local second transaction authentication value can be computed using the technique discussed in stage 570 of the process of FIG. 5.

The ARC value 140 maintained by the secure processing subsystem 110 can be incremented responsive to the message received from the NVM 150 (stage 1220). The secure processing subsystem 110 can be configured to increment the ARC value 140 responsive to the local second transaction authentication value matching the second transaction authentication value received from the NVM 150, which indicates that the write request completed successfully. The response message may indicate that the write could not be completed for some reason other than a transaction authentication value mismatch. The response message can inform the secure processing subsystem 110 of the error. However, both the NVM 150 and the secure processing subsystem 110 can be configured to increment their respective ARC values even though the write request could not be completed to prevent replay attacks.

FIG. 13 is a flow diagram of an example process for securing a write request using an anti-replay counter according to the techniques disclosed herein. The process illustrated in FIG. 13 can be implemented by the NVM 150.

A write request can be received from the secure processing subsystem 110 to write encrypted data to the NVM 150 (stage 1305). The write request may be similar to the write request message illustrated in stage 560 of the example process of FIG. 5. The request can include an address in the NVM 150 at which the data is to be stored, the encrypted data to be stored in the NVM 150 (which may include an authentication tag), and a first transaction authentication value. As discussed above, the first transaction authentication value can be determined by the secure processing subsystem 110 by applying a cryptographic algorithm to the address value associated with the write request and the encrypted data (also referred to as the payload) and the authentication tag associated with the encrypted data (if any). The first authentication value can comprise a message authentication code, which may be generated using a trusted key derived from the secret key 130 using a key derivation function that accepts the current ARC value 140 as a parameter.

The write request can be authenticated based on the first transaction authentication value (stage 1310). The secure processing subsystem can be configured to generate a local first transaction authentication value by applying the same cryptographic algorithm to the address value and/or the encrypted data sent in stage 1305. The NVM 150 can be configured to halt the write process and/or to take other actions responsive to the local first transaction authentication value not matching the first transaction authentication value received from the secure processing subsystem 110. The local first transaction authentication value can be computed using a technique similar to that discussed above with respect to stage 570 of the process of FIG. 5.

A response message can be sent to the secure processing subsystem 110 indicating whether the write request was completed (stage 1310). The response message can include a second transaction authentication value. The second transaction authentication value can be determined by the NVM 150 by applying a cryptographic algorithm to the address value and/or the encrypted data received in stage 1305. The second authentication value can comprise a message authentication code, which may be generated using a trusted key derived from the secret key 160 using a key derivation function that accepts the current ARC value 165 as a parameter. The NVM can be configured to permute the order of the address and the encrypted data when determining the second authentication value, so that first and second authentication values differ and the second authentication value is not merely a replay of the first authentication value sent with the write request in stage 1305.

The response message may indicate that the write could not be completed for some reason other than a transaction authentication value mismatch. The response message can inform the secure processing subsystem 110 of the error. However, both the NVM 150 and the secure processing subsystem 110 can be configured to increment their respective ARC values even though the write request could not be completed to prevent replay attacks.

The ARC value 165 maintained by the NVM 150 can be incremented (stage 1315). The NVM 150 can be configured to increment the ARC value 165 maintained by the NVM 150 once the NVM 150 has authenticated the write request from the secure processing subsystem 110 and has send the response message confirming the write request has been completed to the secure processing subsystem 110. The NVM 150 can also be configured to increment the ARC value 165 prior to sending the response message confirming the write request has been completed.

### Example Implementations of a Non-Volatile Memory

Example implementations of a non-volatile memory according to the disclosure includes one or more of the following examples:
E1. A method for providing data protection in an integrated circuit, the method comprising:

exchanging messages with a secure processing subsystem of the integrated circuit to securely initialize an anti-replay counter (ARC) value in the integrated circuit based on an ARC value stored in off-chip, non-volatile memory; and

maintaining the ARC value stored in the off-chip, non-volatile memory such that the ARC value stored in the off-chip, non-volatile memory remains synchronized with the ARC value stored in the integrated circuit.

E2. The method of example E1, wherein exchanging messages with the secure processing subsystem of the integrated circuit to securely initialize the anti-replay counter (ARC) value in the integrated circuit from the ARC value stored in the off-chip, non-volatile memory further comprises:

sending a message to the integrated circuit that includes the ARC value stored in the off-chip, non-volatile memory and a local first nonce value;

receiving a first response from the integrated circuit that includes a second nonce value and a first cryptogram value computed using a secret key known to the integrated circuit and the off-chip, non-volatile memory; and

sending a second response to the integrated circuit that includes a second cryptogram value computed using the secret key.

E3. The method of example E2, wherein the first cryptogram value comprises a cryptogram computed of the local first nonce value, the second nonce value, and the ARC value.
E4. The method of example E2, further comprising authenticating the first response by:

computing a local cryptogram value using the second nonce value received in the first response and the local first nonce value and ARC; and

comparing the first cryptogram value and the local cryptogram value to determine whether the first response is authentic.

E5. The method of example E2, wherein maintaining the ARC value stored in the off-chip, non-volatile memory such that the ARC value stored in the off-chip, non-volatile memory remains synchronized with the ARC value stored in the integrated circuit further comprises:

receiving a read request from the integrated circuit to obtain encrypted data stored in the off-chip, non-volatile memory, the read request comprising an address in the off-chip, non-volatile memory at which the data is stored and a first transaction authentication value;

authenticating the read request based on the first transaction authentication value; and

responsive to the read request being authenticated,
sending message to the integrated circuit that includes the encrypted data, a MAC or a cryptographic signature associated with the encrypted data, and a second transaction authentication value, and
incrementing the ARC value stored in the off-chip, non-volatile memory.
   E6. The method of example E5, wherein authenticating the read request based on the first transaction authentication value further comprises:

determining a keyed-hash message authentication code (HMAC) of the address in the off-chip, non-volatile memory at which the data is stored and a trusted key, and

comparing the HMAC to the first transaction authentication value.

E7. The method of example E6, further comprising:

determining the trusted key by applying a key derivation function to the secret key and the ARC value stored in the off-chip, non-volatile memory.

E8. The method of example E2, wherein maintaining the ARC value stored in the off-chip, non-volatile memory such that the ARC value stored in the off-chip, non-volatile memory remains synchronized with the ARC value stored in the integrated circuit further comprises:

receiving a write request to write encrypted data to the off-chip, non-volatile memory from the integrated circuit, the write request comprising an address in the off-chip, non-volatile memory at which the data is to be stored, the encrypted data, and a first transaction authentication value;

authenticating the write request based on the first transaction authentication value; and

responsive to the write request being authenticated, incrementing the ARC value stored in the off-chip, non-volatile memory.

E9. The method of example E8, further comprising:

sending message to the integrated circuit that indicates whether the write request was completed.

E10. The method of example E8, wherein authenticating the write request based on the first transaction authentication value further comprises:

determining a keyed-hash message authentication code (HMAC) of the address in the off-chip, non-volatile memory at which the data is stored and the data to be stored using a trusted key, and

comparing the HMAC to the first transaction authentication value.

E11. The method of example E10, further comprising:

determining the trusted key by applying a key derivation function to the secret key and the ARC value stored in the off-chip, non-volatile memory.

E12. An integrated circuit comprising:

means for exchanging messages with a secure processing subsystem of the integrated circuit to securely initialize an anti-replay counter (ARC) value in the integrated circuit based on an ARC value stored in off-chip, non-volatile memory; and

means for maintaining the ARC value stored in the off-chip, non-volatile memory such that the ARC value stored in the off-chip, non-volatile memory remains synchronized with the ARC value stored in the integrated circuit.

E13. The integrated circuit of example E12, wherein the means for exchanging messages with the secure processing subsystem of the integrated circuit to securely initialize the anti-replay counter (ARC) value in the integrated circuit from the ARC value stored in the off-chip, non-volatile memory further comprises:

means for sending a message to the integrated circuit that includes the ARC value stored in the off-chip, non-volatile memory and a local first nonce value;

means for receiving a first response from the integrated circuit that includes a second nonce value and a first cryptogram value computed using a secret key known to the integrated circuit and the off-chip, non-volatile memory; and

means for sending a second response to the integrated circuit that includes a second cryptogram value computed using the secret key.

E14. The integrated circuit of example E13, wherein the first cryptogram value comprises a cryptogram computed of the local first nonce value, the second nonce value, and the ARC value.
E15. The integrated circuit of example E13, further comprising means for authenticating the first response, the means for authenticating comprising:

means for computing a local cryptogram value using the second nonce value received in the first response and the local first nonce value and ARC; and

means for comparing the first cryptogram value and the local cryptogram value to determine whether the first response is authentic.

E16. The integrated circuit of example E13, wherein the means for maintaining the ARC value stored in the off-chip, non-volatile memory such that the ARC value stored in the off-chip, non-volatile memory remains synchronized with the ARC value stored in the integrated circuit further comprises:

means for receiving a read request from the integrated circuit to obtain encrypted data stored in the off-chip, non-volatile memory, the read request comprising an address in the off-chip, non-volatile memory at which the data is stored and a first transaction authentication value;

means for authenticating the read request based on the first transaction authentication value; and

responsive to the read request being authenticated,
means for sending message to the integrated circuit that includes the encrypted data, a MAC or a cryptographic signature associated with the encrypted data, and a second transaction authentication value, and
means for incrementing the ARC value stored in the off-chip, non-volatile memory.
   E17. The integrated circuit of example E16, wherein the means for authenticating the read request based on the first transaction authentication value further comprises:

means for determining a keyed-hash message authentication code (HMAC) of the address in the off-chip, non-volatile memory at which the data is stored and a trusted key, and

means for comparing the HMAC to the first transaction authentication value.

E18. The integrated circuit of example E17, further comprising:

means for determining the trusted key by applying a key derivation function to the secret key and the ARC value stored in the off-chip, non-volatile memory.

E19. The integrated circuit of example E13, wherein the means for maintaining the ARC value stored in the off-chip, non-volatile memory such that the ARC value stored in the off-chip, non-volatile memory remains synchronized with the ARC value stored in the integrated circuit further comprises:

means for receiving a write request to write encrypted data to the off-chip, non-volatile memory from the integrated circuit, the write request comprising an address in the off-chip, non-volatile memory at which the data is to be stored, the encrypted data, and a first transaction authentication value;

means for authenticating the write request based on the first transaction authentication value; and

means for incrementing the ARC value stored in the off-chip, non-volatile memory responsive to the write request being authenticated.

E20. The integrated circuit of example E19, further comprising:

means for sending message to the integrated circuit that indicates whether the write request was completed.

E21. The integrated circuit of example E19, wherein the means for authenticating the write request based on the first transaction authentication value further comprises:

means for determining a keyed-hash message authentication code (HMAC) of the address in the off-chip, non-volatile memory at which the data is stored and the data to be stored using a trusted key, and

means for comparing the HMAC to the first transaction authentication value.

E22. The integrated circuit of example E21, further comprising:

means for determining the trusted key by applying a key derivation function to the secret key and the ARC value stored in the off-chip, non-volatile memory.

E23. An integrated circuit comprising a secure processing subsystem configured to:

exchange messages with a secure processing subsystem of the integrated circuit to securely initialize an anti-replay counter (ARC) value in the integrated circuit based on an ARC value stored in off-chip, non-volatile memory; and

maintain the ARC value stored in the off-chip, non-volatile memory such that the ARC value stored in the off-chip, non-volatile memory remains synchronized with the ARC value stored in the integrated circuit.

E24. The integrated circuit of example E23, wherein the secure processing subsystem being configured to exchange messages with the secure processing subsystem of the integrated circuit to securely initialize the anti-replay counter (ARC) value in the integrated circuit from the ARC value stored in the off-chip, non-volatile memory is further configured to:

send a message to the integrated circuit that includes the ARC value stored in the off-chip, non-volatile memory and a local first nonce value;

receive a first response from the integrated circuit that includes a second nonce value and a first cryptogram value computed using a secret key known to the integrated circuit and the off-chip, non-volatile memory; and

send a second response to the integrated circuit that includes a second cryptogram value computed using the secret key.

E25. The integrated circuit of example E24, wherein the first cryptogram value comprises a cryptogram computed of the local first nonce value, the second nonce value, and the ARC value.
E26. The integrated circuit of example E24, wherein the secure processing subsystem is configured to authenticate the first response, the secure processing subsystem being further configured to:

compute a local cryptogram value using the second nonce value received in the first response and the local first nonce value and ARC; and

compare the first cryptogram value and the local cryptogram value to determine whether the first response is authentic.

E27. The integrated circuit of example E24, wherein the secure processing subsystem being configured to maintain the ARC value stored in the off-chip, non-volatile memory such that the ARC value stored in the off-chip, non-volatile memory remains synchronized with the ARC value stored in the integrated circuit is further configured to:

receive a read request from the integrated circuit to obtain encrypted data stored in the off-chip, non-volatile memory, the read request comprising an address in the off-chip, non-volatile memory at which the data is stored and a first transaction authentication value;

authenticate the read request based on the first transaction authentication value; and

responsive to the read request being authenticated,
send a message to the integrated circuit that includes the encrypted data, a MAC or a cryptographic signature associated with the encrypted data, and a second transaction authentication value, and
increment the ARC value stored in the off-chip, non-volatile memory.
   E28. The integrated circuit of example E27, wherein the secure processing subsystem being configured to authenticate the read request based on the first transaction authentication value is further configured to:

determine a keyed-hash message authentication code (HMAC) of the address in the off-chip, non-volatile memory at which the data is stored and a trusted key, and

compare the HMAC to the first transaction authentication value.

E29. The integrated circuit of example E28, wherein the secure processing subsystem is further configured to:

determine the trusted key by applying a key derivation function to the secret key and the ARC value stored in the off-chip, non-volatile memory.

E30. The integrated circuit of example E24, wherein the secure processing subsystem being configured to maintain the ARC value stored in the off-chip, non-volatile memory such that the ARC value stored in the off-chip, non-volatile memory remains synchronized with the ARC value stored in the integrated circuit is further configured to:

receive a write request to write encrypted data to the off-chip, non-volatile memory from the integrated circuit, the write request comprising an address in the off-chip, non-volatile memory at which the data is to be stored, the encrypted data, and a first transaction authentication value;

authenticate the write request based on the first transaction authentication value; and

responsive to the write request being authenticated, increment the ARC value stored in the off-chip, non-volatile memory.

E31. The integrated circuit of example E30, further comprising:

send a message to the integrated circuit that indicates whether the write request was completed.

E32. The integrated circuit of example E31, wherein the secure processing subsystem being configured to authenticate the write request based on the first transaction authentication value is further configured to:

determine a keyed-hash message authentication code (HMAC) of the address in the off-chip, non-volatile memory at which the data is stored and the data to be stored using a trusted key, and

compare the HMAC to the first transaction authentication value.

E33. The integrated circuit of example E32, wherein the secure processing subsystem is further configured to:

determine the trusted key by applying a key derivation function to the secret key and the ARC value stored in the off-chip, non-volatile memory.

E34. A non-transitory, computer-readable medium, having stored thereon computer-readable instructions for providing data protection in an integrated circuit, comprising instructions configured to cause a computer to:

exchange messages with a secure processing subsystem of the integrated circuit to securely initialize an anti-replay counter (ARC) value in the integrated circuit based on an ARC value stored in off-chip, non-volatile memory; and

maintain the ARC value stored in the off-chip, non-volatile memory such that the ARC value stored in the off-chip, non-volatile memory remains synchronized with the ARC value stored in the integrated circuit.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for providing data protection in an integrated circuit, the method comprising:
exchanging messages with an off-chip, non-volatile memory to securely initialize an anti-replay counter (ARC) value in the integrated circuit based on an ARC value stored in the off-chip, non-volatile memory; and
maintaining the ARC value stored in the integrated circuit such that the ARC value stored in the integrated circuit remains synchronized with the ARC value stored in the off-chip, non-volatile memory.

2. The method of claim 1, wherein exchanging messages with the off-chip, non-volatile memory to securely initialize the anti-replay counter (ARC) value in the integrated circuit from the ARC value stored in the off-chip, non-volatile memory further comprises:
receiving a message from the off-chip, non-volatile memory that includes the ARC value stored in the off-chip, non-volatile memory and a first nonce value;
sending a first response from the integrated circuit that includes a local second nonce value and a first cryptogram value encrypted using a secret key known to the integrated circuit and the off-chip, non-volatile memory; and
receiving a second response to the integrated circuit that includes a second cryptogram value encrypted using the secret key.

3. The method of claim 2, wherein the first cryptogram value comprises a cryptogram computed of the first nonce value, second nonce value, and the ARC value.

4. The method of claim 2, further comprising authenticating the second response by:
computing a local cryptogram using the first nonce value received in the message from the off-chip, non-volatile memory, and the local second nonce value and the ARC value; and
comparing the second cryptogram value and the local cryptogram to determine whether the second response is authentic.

5. The method of claim 2, wherein maintaining the ARC value stored in the integrated circuit such that the ARC value stored in the integrated circuit remains synchronized with the ARC value stored in the off-chip, non-volatile memory further comprises:
sending a read request from the integrated circuit to obtain encrypted data stored in the off-chip, non-volatile memory, the read request comprising an address in the off-chip, non-volatile memory at which the data is stored and a first transaction authentication value;
receiving a response message from the off-chip, non-volatile memory that includes the encrypted data, a MAC or a cryptographic signature associated with the data, and a second transaction authentication value;
authenticating the response message based on the second transaction authentication value; and
responsive to the response message being authenticated, incrementing the ARC value stored in the integrated circuit.

6. The method of claim 5, wherein authenticating the response message based on the second transaction authentication value further comprises:
determining a keyed-hash message authentication code (HMAC) of the address in the off-chip, non-volatile memory at which the data was to be read using a trusted key and the encrypted data received with the response message, and
comparing the HMAC to the second transaction authentication value.

7. The method of claim 6, further comprising:
determining the trusted key by applying a key derivation function to the secret key and the ARC value stored in the integrated circuit.

8. The method of claim 2, wherein maintaining the ARC value stored in the integrated circuit such that the ARC value stored in the integrated circuit remains synchronized with the ARC value stored in the off-chip, non-volatile memory further comprises:
sending a write request to write encrypted data to the off-chip, non-volatile memory from the integrated circuit, the write request comprising an address in the off-chip, non-volatile memory at which the data is to be stored, the encrypted data, and a first transaction authentication value;
receiving a response message from the off-chip, non-volatile memory that the write request was completed, the response message comprising a second transaction authentication value;
authenticating the response message based on the second transaction authentication value; and
responsive to the response message being authenticated, incrementing the ARC value stored in the off-chip, non-volatile memory.

9. The method of claim 8, wherein authenticating the response message based on the second transaction authentication value further comprises:
determining a keyed-hash message authentication code (HMAC) of the address and the encrypted data send with the write request using a trusted key, and
comparing the HMAC to the second transaction authentication value.

10. The method of claim 9, further comprising:
determining the trusted key by applying a key derivation function to the secret key and the ARC value stored in the off-chip, non-volatile memory.

11. An integrated circuit comprising:
means for exchanging messages with an off-chip, non-volatile memory to securely initialize an anti-replay counter (ARC) value in the integrated circuit based on an ARC value stored in the off-chip, non-volatile memory; and
means for maintaining the ARC value stored in the integrated circuit such that the ARC value stored in the integrated circuit remains synchronized with the ARC value stored in the off-chip, non-volatile memory.

12. The integrated circuit of claim 11, wherein the means for exchanging messages with the off-chip, non-volatile memory to securely initialize the anti-replay counter (ARC) value in the integrated circuit from the ARC value stored in the off-chip, non-volatile memory further comprises:
means for receiving a message from the off-chip, non-volatile memory that includes the ARC value stored in the off-chip, non-volatile memory and a first nonce value;
means for sending a first response from the integrated circuit that includes a local second nonce value and a first cryptogram value encrypted using a secret key known to the integrated circuit and the off-chip, non-volatile memory; and
means for receiving a second response to the integrated circuit that includes a second cryptogram value encrypted using the secret key.

13. The integrated circuit of claim 12, wherein the first cryptogram value comprises a cryptogram computed of the first nonce value, second nonce value, and the ARC value.

14. The integrated circuit of claim 12, further comprising means for authenticating the second response comprising:
means for computing a local cryptogram using the first nonce value received in the message from the off-chip, non-volatile memory, and the local second nonce value and the ARC value; and
means for comparing the second cryptogram value and the local cryptogram to determine whether the second response is authentic.

15. The integrated circuit of claim 12, wherein the means for maintaining the ARC value stored in the integrated circuit such that the ARC value stored in the integrated circuit remains synchronized with the ARC value stored in the off-chip, non-volatile memory further comprises:
means for sending a read request from the integrated circuit to obtain encrypted data stored in the off-chip, non-volatile memory, the read request comprising an address in the off-chip, non-volatile memory at which the data is stored and a first transaction authentication value;
means for receiving a response message from the off-chip, non-volatile memory that includes the encrypted data, a MAC or a cryptographic signature associated with the data, and a second transaction authentication value;
means for authenticating the response message based on the second transaction authentication value; and
means for responsive to the response message being authenticated, incrementing the ARC value stored in the integrated circuit.

16. A computing device comprising:
an integrated circuit including:
a secure processing subsystem configured to:
exchange messages with an off-chip, non-volatile memory to securely initialize an anti-replay counter (ARC) value in the integrated circuit based on an ARC value stored in the off-chip, non-volatile memory; and
maintain the ARC value stored in the integrated circuit such that the ARC value stored in the integrated circuit remains synchronized with the ARC value stored in the off-chip, non-volatile memory.

17. The computing device of claim 16, wherein the secure processing subsystem being configured to exchange messages with the off-chip, non-volatile memory to securely initialize the anti-replay counter (ARC) value in the integrated circuit from the ARC value stored in the off-chip, non-volatile memory is further configured to:
receive a message from the off-chip, non-volatile memory that includes the ARC value stored in the off-chip, non-volatile memory and a first nonce value;
send a first response from the integrated circuit that includes a local second nonce value and a first cryptogram value encrypted using a secret key known to the integrated circuit and the off-chip, non-volatile memory; and
receive a second response to the integrated circuit that includes a second cryptogram value encrypted using the secret key.

18. The computing device of claim 17, wherein the first cryptogram value comprises a cryptogram computed of the first nonce value, second nonce value, and the ARC value.

19. The computing device of claim 17, where the secure processing subsystem is configured to authenticate the second response, the secure processing subsystem being further configured to:
compute a local cryptogram using the first nonce value received in the message from the off-chip, non-volatile memory, and the local second nonce value and the ARC value; and
compare the second cryptogram value and the local cryptogram to determine whether the second response is authentic.

20. The computing device of claim 17, wherein the secure processing being configured to maintain the ARC value stored in the integrated circuit such that the ARC value stored in the integrated circuit remains synchronized with the ARC value stored in the off-chip, non-volatile memory further is further configured to:
send a read request from the integrated circuit to obtain encrypted data stored in the off-chip, non-volatile memory, the read request comprising an address in the off-chip, non-volatile memory at which the data is stored and a first transaction authentication value;
receive a response message from the off-chip, non-volatile memory that includes the encrypted data, a MAC or a cryptographic signature associated with the data, and a second transaction authentication value;
authenticate the response message based on the second transaction authentication value; and
increment the ARC value stored in the integrated circuit responsive to the response message being authenticated.
